(19) United States
(12) Patent Application Publication
(10) Pub. No.: US 2019/0213820 A1
(43) Pub. Date: Jul. 11, 2019

(54) SECURE BALLOTING AND ELECTION SYSTEM

(71) Applicant: OSET Foundation

(72) Inventors: John Sebes, Menlo Park, CA (US); Gregory Miller, Portland, OR (US); John Hornbaker, III, San Francisco, CA (US); Aleksander Totic, Palo Alto, CA (US); Hugh Dubberly, San Francisco, CA (US); Pito Salas, Arlington, MA (US)

(21) Appl. No.: 14/791,218

(22) Filed: Jul. 2, 2015

Related U.S. Application Data
(60) Provisional application No. 62/020,211, filed on Jul. 2, 2014.

(51) Int. Cl. G07C 13/00

(52) U.S. Cl. CPC G07C 13/00

(57) ABSTRACT

A system to configure, manage, and execute voting includes a voter console device and a server system. The voter console is operable to communicate a digital voter identification corresponding to a voter to the server system over a first communication channel. The server system applying the digital voter identification to a voter associator device and a geo-temporal associator device to identify a ballot layout for the voter for a configured future election event. The server system applies the ballot layout to generate a ballot for the voter for the configured future election event. The server system communicates the ballot digitally to the voter console device, and forms a digital package including the digital voter identification and a representation of the ballot as completed by the voter. The voter console communicates the digital package over a second communication channel independent and separate from the first communication channel, the second communication channel providing intrusion-protected and anonymous transport of the digital package to the server system. The server system separates the digital voter identification from the representation of the ballot as completed by the voter and to count and tally votes identified from marks made to the representation of the ballot as completed by the voter.

### CROSS-REFERENCE TO RELATED APPLICATIONS

This application claims priority and benefit under 35 U.S.C. 119 to U.S. application Ser. No. 62/020,211, filed on 2 Jul. 2014, which is incorporated herein by reference in its entirety.

### BACKGROUND

An election is a formal decision-making process by which a population selects one or more individuals to fill positions in governments, public organizations, or private organizations. This process is also used in many private and business organizations. An improved election process is desired to reduce costs and improve the efficiency of the voting process while improving the accuracy of the voting results.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates at a high level an embodiment of a client-server voting system 100.

FIG. 2 illustrates an embodiment of an election system 200.

FIG. 3 illustrates an example of a high level election process 300.

FIG. 4 illustrates an embodiment of a voter registration system 400.

FIG. 5 illustrates an embodiment of a voter authentication system 500.

FIG. 6 illustrates an embodiment of a voter registration validation system 600.

FIG. 7 illustrates an embodiment of a pollbook generation system 700.

FIG. 8 is a system diagram of an embodiment of a system for controlling ballot access.

FIG. 9 illustrates a ballot access control routine 900 in accordance with one embodiment.

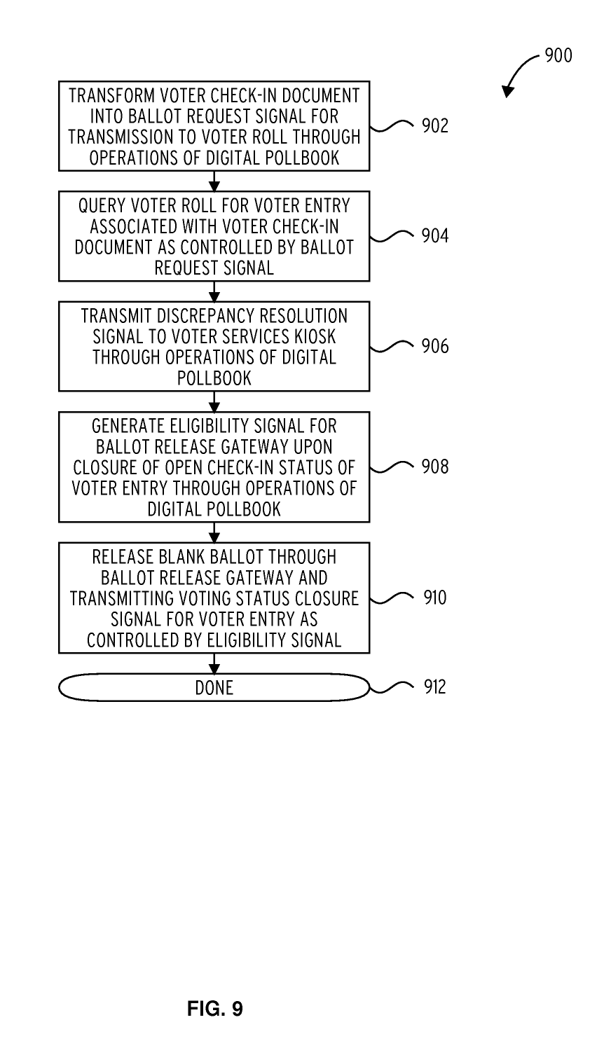

FIG. 10 is a system diagram of an embodiment of the system receiving voter check-in documents.

FIG. 11 is a system diagram of an embodiment of the system identifying matches and discrepancies.

FIG. 12 is a system diagram of an embodiment of the system resolving discrepancies through a voter services kiosk.

FIG. 13 is a system diagram of an embodiment of the ballot access control system displaying the release of a ballot through the ballot release gateway.

FIG. 14 illustrates an embodiment of a ballot generation system 1400.

FIG. 15 illustrates an embodiment of an election execution process 1500.

FIG. 16 illustrates an embodiment of a ballot adjudication process 1600.

FIG. 17 illustrates an embodiment of a ballot counting process 1700.

FIG. 18 illustrates an embodiment of a ballot counting process 1800.

FIG. 19 illustrates an example of a paper ballot 1900.

FIG. 20 illustrates a grid schema for a paper ballot 1900.

FIG. 21 illustrates an embodiment of a ballot scanning process 2100.

FIG. 22 illustrates an embodiment of a voter response area identification process 2200.

FIG. 23 illustrates an embodiment of a ballot counting process 2300.

FIG. 24 illustrates an embodiment of a ballot tabulation apparatus 2400.

FIG. 25 is a figure describing an embodiment of an integrity verification system 2500 for configuring and validating a ballot casting and counting device.

FIG. 26 illustrates an embodiment of a device manager 2600.

FIG. 27 is a figure illustrating an embodiment of a hardware diagnostic module 2706 of a hardware diagnostic system 2700.

FIG. 28 illustrates a routine 2800 for configuring and validating a ballot casting and counting device in accordance with one embodiment.

FIG. 29 illustrates an embodiment of an application data screener, gateway and gateway actuator 2900.

FIG. 30 illustrates an embodiment of a process of validation application code files 3000.

FIG. 31 illustrates a routine for configuring and validating a ballot casting and counting device 3100.

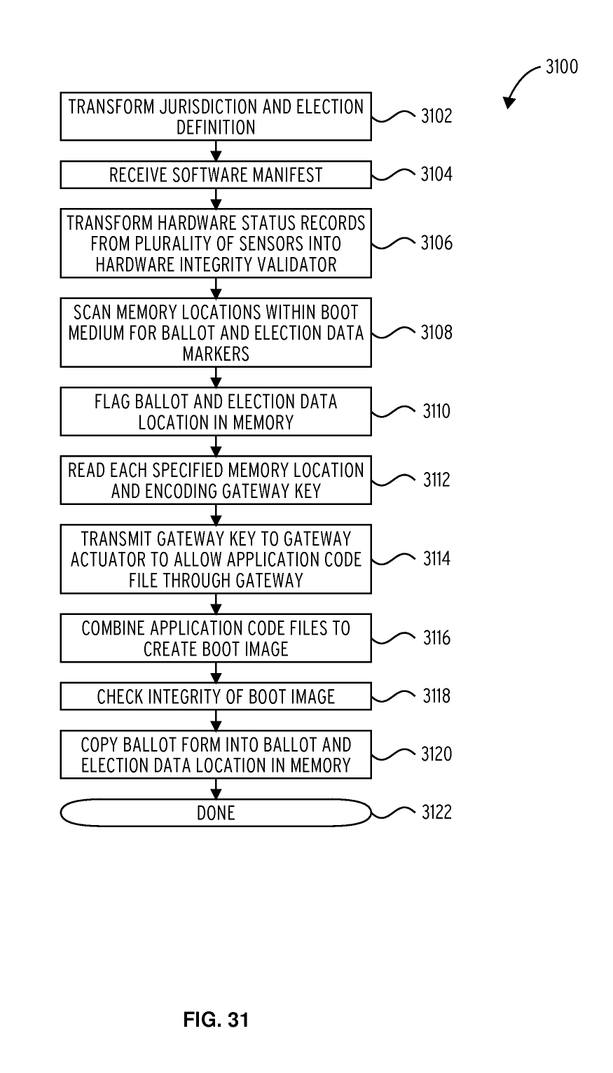

### DETAILED DESCRIPTION

### Description

The present disclosure provides, in some embodiments, an improved voting managing system for automating a voting process in a jurisdiction. “Jurisdiction” in this document is a general term for a geographical, political, or other division of a population.

Other aspects and embodiments of the disclosure are also contemplated. The following detailed description is not meant to restrict the disclosure to any particular embodiment but is merely meant to describe some embodiments of the disclosure.

### Drawings

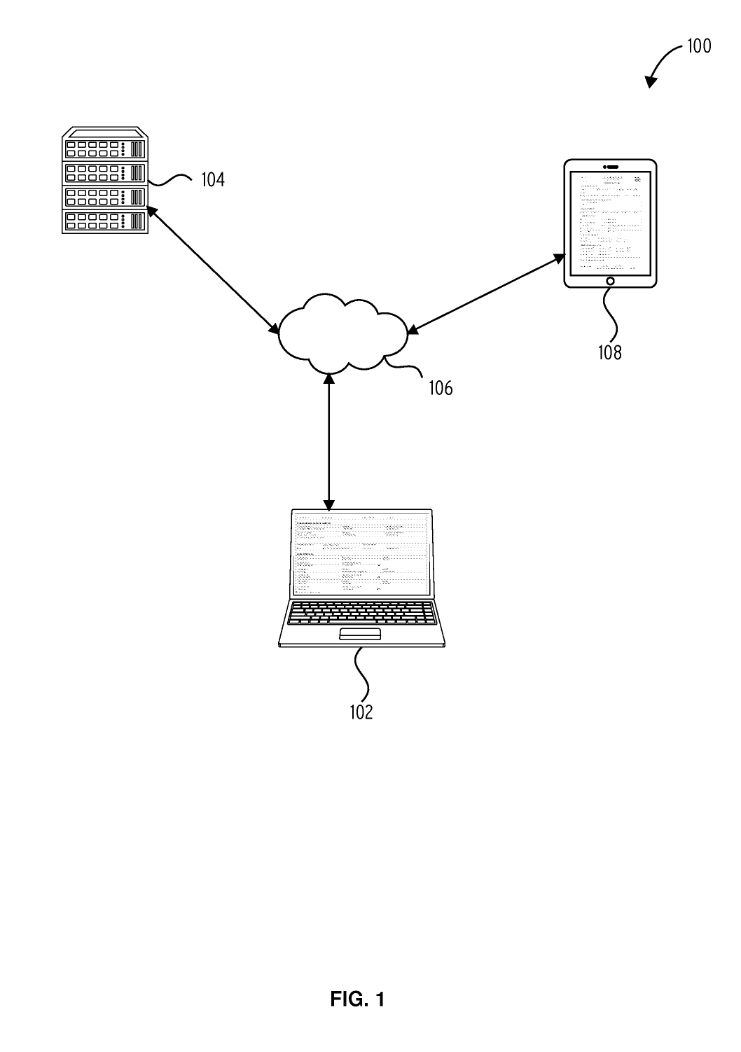

FIG. 1 illustrates at a high level an embodiment of a client-server voting system 100. The client-server voting system 100 comprises an administration console 102, a voter terminal device 108, and a management system 104 communicatively coupled via a network 106.

The administration console 102 provides a control terminal from which election officials may define, administer, and execute elections. The voter terminal device 108 provides a control terminal from which voters may register and vote in elections. The management system 104 operates to synthesize the actions of the voters and the election officials before, during, and after elections.

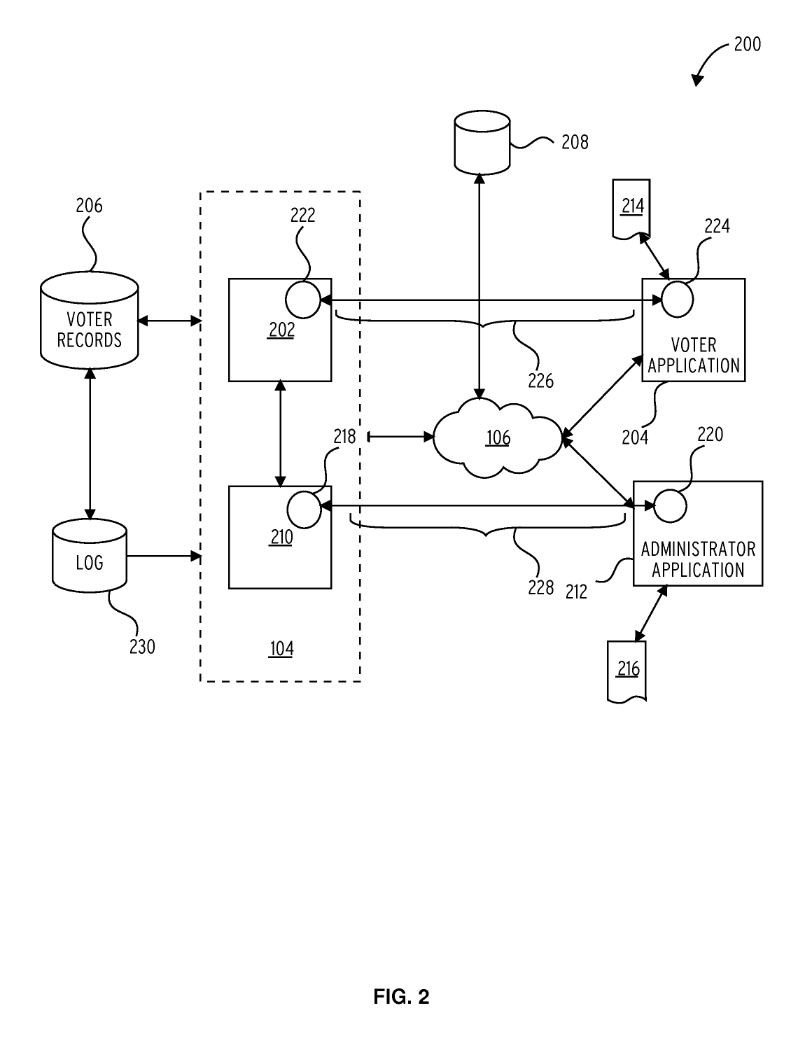

FIG. 2 illustrates an embodiment of an election system 200. The election system 200 comprises a voter application 204 and an administrator application 212. The voter application 204 is implemented by logic of the management system 104 as configured by jurisdictional settings 214. The administrator application 212 is implemented by logic of the administration console 102 as configured by jurisdictional settings 216.

The election system 200 further comprises the management system 104. The management system 104 comprises a voter module 202 and an administrator module 210, which interact with one another and with the voter application 204 and the administrator application 212, respectively. The voter module 202 and the voter application 204 communicate via a secure channel 226 established by client-side authenticator 224 and voter authenticator 222 at the management system 104 and voter module 202, respectively. The administrator application 212 and the administrator module 210 communicate via a secure channel established by the client-side authenticator 220 and the admin authenticator 218 of the administration console 102 and the administrator module 210, respectively.

Authentication of voters and also possibly election officials may in some implementations be facilitated by an external associator 208, e.g., a Department of Motor Vehicles (DMV) driver registration database.

Transactions implemented via operation of the management system 104 may be recorded in a transaction log 230. The transaction log 230 may also be accessed to facilitate transactions. The management system 104 may also operate to read and write data to a voting associator 206, e.g. a voter registration database. The voting associator 206 and transaction log 230 may be useful for example to register voters, to authenticate voters, to generate pollbooks, to provide ballots to voters, and to carry out voting by voters, among other things.

In some embodiments, the election system 200 captures a voter's registration information in the course of creating a printable voter registration form. The voter registration information may be provided in real time and stored via a network interface between the voter module 202 and the voter application 204.

In some embodiments, the voter application 204 may be implemented as a web application. In some embodiments, the voter application 204 can be of other manifestations, such as email-based transactions, mobile apps using back-end systems via a web-services interface, or a client/server system with a native client application on a conventional personal computer.

In some embodiments, a voter logs in to the voter application 204 through proper identification and authentication, and enters registration information. The entered registration information is sent to the voter module 202 through a network. The voter module 202 maps the voter entered registration information, and communicates with the voting associator 206 through a structured query language (SQL).

In some embodiments, a registered voter can access information stored in the voting associator 206, via the voter application 204 to query the database, view registration status, and perform other transactions as discussed later in the present disclosure. The term “access” in this context may include self-identification, and in some implementations, may also include authentication.

An administrator, e.g. a local election official (LEO) can log in to the administrator module 210 through the administrator application 212 (e.g., a web application), and access the voting associator 206 and transaction log 230. Throughout this description, the term LEO will be used as an example for any election administration official.

In some embodiments, the voting associator 206 may be an existing legacy database. The management system 104 may be compatible with different database structures and SQLs with different extensions, and thus can map the data and commands between different databases.

In some embodiments, the secure channel 226 and secure channel 228 utilize secure transfer protocols and/or encryption. For example, a secure channel may be a TCP/IP session, the contents of which are protected by encryption.

In some embodiments, transactions that involve accessing the management system 104 and/or the voting associator 206 can be recorded and saved in a transaction log 230. Duplicated copies of the transaction log 230 can be saved in more than one location.

In some embodiments, each transaction item in the transaction log 230 may include information such as the date and time of the transaction, voter identification or LEO identification, transaction codes or identification numbers, and result(s) of the transaction. The transaction codes may be, for example, one of a new registration, a user update, an LEO review, an absentee ballot request, and a voter registration card request.

In some embodiments, the transaction log 230, along with user registration data, can be used for reporting and analytics, and for improving the management system 104 and/or voting associator 206.

Election officials can access voter record databases for various purposes in preparing for elections. For example, the election official may process a voter registration request, and determine the voter's eligibility using data managed by the voting associator 206. In some embodiments, the election officials may also create voter rolls for voters eligible for a specific election using the voter registration information.

In some embodiments, election officials perform a voter eligibility process using the voting associator 206 to define a list of voters who may vote in each election. In most jurisdictions, inclusion in a voter list is governed by a registration process that is managed by LEOs. In such voter registration jurisdictions, voters perform the various preparation actions, resulting in a variety of request documents. The request documents may be paper documents or digital representations of the same information; and the paper documents may be transformed into a digital representation before being processed. The various requests may include voter registration requests, voter registration updates, absentee ballot requests, absentee status requests, statements of disability, and requests that combine multiple of these requests.

In some embodiments, voter request processing may include processing on a paper request, and digitizing the request information afterwards. In some embodiments, no digitization is performed.

In some embodiments, during the election preparation process, the LEOs accept or reject each request based on federal and state election law, the information provided in the request, and a comparison with external data sources such as Department of Corrections records or registers of deceased persons. In case where a new registration request is approved, a new voter record is created from that request. In case where a request is approved for a registered voter, an existing voter record is updated based on the request. In case where a new registration request is denied, a record of the rejection might or might not be kept.

In some embodiments, the voter registration request can be processed in real time by accessing and verifying voter information available in other governmental or third party databases.

As a part of maintaining a set of voter records, in some embodiments, the LEOs may perform on-going management of the voter list by periodically matching existing records with external data sources, such as those used in registration.

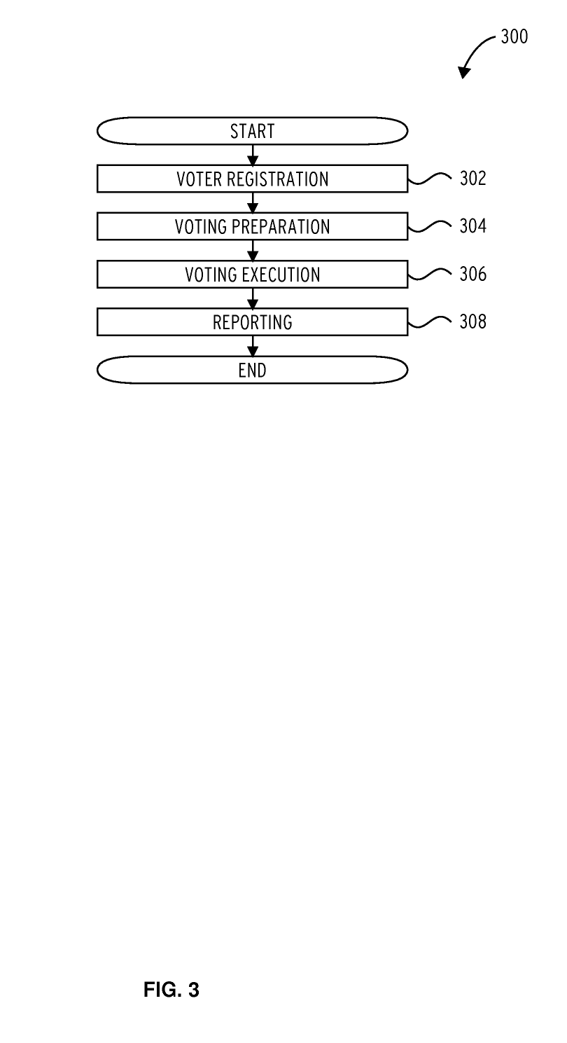

FIG. 3 illustrates an example of a high level election process 300.

The high level election process 300 begins at block 302 with voter registration. Voters are registered to cast votes in particular elections in particular voting districts, which may be local, state-wide, or national (e.g., in the USA). Next is voting preparation at block 304, which configures the election system 200 for the voting process overall and the casting of ballots specifically. Next is voting execution at block 306, the acceptance, validation, and counting of ballots. Finally is election reporting, which is certification and dissemination of election results, at block 308.

A voter can submit a voter registration request using the management system 104 or other alternatives. In some embodiments, the voter registration process may include: (1) a voter creates a voter registration request form; (2) the voter sends the voter registration request form to a voter registration office, a registrar of voters, a county clerk office, or other election administration office; and (3) LEOs accept or reject the request based on eligibility criteria, and a voter registration record is created and stored if the request is accepted.

In some jurisdictions, the voter registration request must be in the form of a paper request with a hand-inked signature. In such case, voter information may be entered into the voting associator 206 by keying the hand written text, and the signature can be retained by either or both of retaining the signed paper document and optically scanning the signature and retaining the digital image in the voting associator 206.

In some jurisdictions, a paper document may be part of the approval process. In some embodiments, the paper document may include a bar code, a quick response (QR) code, or other similar code used by LEOs to look up previously provided digital form data if applicable. In some embodiments, the barcode can encode the entirety of the voter information as an alternative to manually re-keying the data. In some embodiments, the printed request can be created in a format that is friendly for an optical character recognition system to acquire voter information by scanning the printed request.

In some jurisdictions, voters may also register by a personal visit or a phone call to submit the request and supporting information.

In some embodiments, the voter may use the voter application 204 to provide voter information which is included in a generated printable document that the voter may print, sign, and return to an LEO. This reduces risk of data entry errors stemming from poor handwriting because the text is computer generated, and also reduces the risk of rejection of the request for incompleteness because the software can help the voter to understand what information is required and make sure the required information is provided before printing. Risk of error is further reduced by providing the voter request from the voter application 204 in digital form to the voting associator 206, so that no data entry is required after the request submitted. In this implementation, a signed paper may be submitted separately, which is then indexed to the digital form.

One form of voter registration is a paperless on-line voter registration request, which may typically be embodied in an election system 200, but may also be embodied in other methods. In some embodiments, a voter may opt to provide sufficient information online to locate an existing government record with a signature previously provided, such as, for example, a driver's license or a state ID card record maintained by an agency such as the Motor Vehicle Department. If the voter provides sufficient information for a match, the agency retaining the signature can provide the management system 104 with an image of the signature, such that the hand-inked signature on paper may not be not needed. Therefore, the voter's registration information can be entered into the voting associator 206 as an all-digital voter request form, and paper form handling may be reduced or eliminated.

Voting preparation (block 304) takes place before an election (voting execution), as voters prepare to vote by confirming their eligibility to vote, and optionally gaining the ability to vote remotely by obtaining an absentee ballot in certain form.

In jurisdictions where voter registration is required, a voter generally first registers to vote in order to be eligible to cast a ballot. A local election official (LEO) accepts or rejects the registration request based on eligibility criteria. LEOs may also create, store, update, and manage voter records.

In some embodiments of the present disclosure, the high level election process 300 may be implemented using a web application accessed through a computer and a web browser, a native application on a computer, a native app on a mobile device, or a general-purpose software tool such as a portable document format (PDF) reader-writer that can help the voter fill in a downloaded form.

Election officials perform a wide variety of election management tasks for an individual election, one of which is to design ballots. For a given election, there may be one or more ballots, such as for different precincts.

EOs may use the management system 104 to manage jurisdiction and election data and create a set of legally compliant ballots. In some embodiments, LEOs create ballots for a specific election utilizing the management system 104 to manage both the jurisdictional data and the election-specific information.

In some embodiments, the management system 104 manages jurisdictional data such as electoral districts, jurisdictional units of voting (e.g., precincts or precinct splits), jurisdictional units for vote reporting (e.g., precincts or vote tallying districts), changes to jurisdictional units as a result of outside activities (e.g., re-districting), changes per law or regulation (e.g., resizing precincts exceeding maximum size), or changes based on an individual election (e.g., consolidating precincts into reporting precincts). An end result of this data management is the creation of a list of sub-jurisdictions (the minimum jurisdiction hereinafter referred to as a precinct by way of convenient terminology, but not as a limiting nomenclature). Each precinct may be a portion of one or more larger sub-jurisdictions, generally referred to as an electoral district, and voters in the precinct may be eligible to vote on ballot items related to not only the precinct, but also the larger sub-jurisdictions and jurisdiction.

In some embodiments, the various electoral districts and geographic data combine to define the set of ballots needed for that election in that jurisdiction. During a part of the pre-election time frame, this jurisdiction definition may be in flux. However, at a legally defined point in time, typically the deadlines for re-districting and other subsidiary activities, the jurisdiction definition is fixed for the upcoming election.

The management system 104 also manages election-specific information including, for example, end-of-term offices for which a regular contest is held; vacant offices for which a special contest is held; referenda placed by government bodies; referenda created by public request; candidates for offices; ballot responses to referenda; and a variety of related qualifications that a candidate or a referendum must meet according to the pre-requisites in state law. This process is referred to as election definition.

During a part of the pre-election time frame, the election definition may be in flux. However, at a legally defined point in time, typically the deadlines for candidate qualification and other subsidiary activities, the election definition is fixed for the upcoming election such that there is a complete list of the contests, candidates, and referenda that comprise the election in that jurisdiction. Because the election definition depends upon and includes a jurisdiction definition for that election, it is referred to as a jurisdiction and election definition (JED).

After generating a JED for each precinct, the actual contents of each ballot can be designed and generated by applying the specific rules and constraints of the jurisdiction. In some embodiments, the ballot design may include: (1) defining the list of contests and referenda for each precinct's ballot; (2) applying legal rules and regulations for how to present each item for each ballot, along with other requirements; (3) designing a ballot layout for paper ballots; (4) applying the design to each ballot definition to create printable ballots; and (5) similar design and application of rules for ballots to be presented digitally.

In some embodiments, the ballot creation process disclosed herein can be performed as a part of an integrated election management process. The design process may be used for each precinct to generate election specific ballots for each precinct. The design process can be highly automated to reduce the amount of manual work by LEOs.

In some embodiments, the ballot design process is at least partially decoupled from the JED creation process. The literal content of the ballots (e.g. names of candidates) is defined by an independently created JED and a set of ballot design rules that can be adjusted on a per-jurisdiction basis. In some implementations, the JED creation process is fully decoupled from the ballot design process, and a completed JED is provided to the ballot design system.

In addition to the processes of ballot definition, design, and rendering, in some embodiments, certain types of counting technology require additional configuration data that is produced in parallel to the ballot rendering process. For example, an optical-scan ballot counting system may require both a JED and information that maps each of the several specific regions of a ballot page to a candidate choice defined in the JED. This combination of data is sometimes referred to as a ballot definition file or an election definition file, the details of which vary with the specific mechanism for detecting and recording voters' choices.

Voting execution involves the marking and submission of ballots, and tallying the ballot choices (votes).

After a voter has checked in and has been given access to a blank ballot, the voter may then create a marked ballot that indicates choice(s) in each ballot item, and cast the ballot for counting.

In some embodiments, the ballot marking method may include at least one of: (1) hand marking a pre-printed paper ballot using ink or perforation; (2) interacting with a voting machine to view ballot options and indicate choices that are directly recorded on the voting machine, referred to as a direct record election (DRE) device; and (3) interacting with a voting machine to view ballot options and indicate choices that are later printed to produce a marked paper ballot, referred to as a ballot marking device (BMD).

In some embodiments, digital ballot marking is the process of: (1) creating a marked paper ballot using computer hardware and software (e.g., a BMD) to present ballot items to a user; (2) confirming the user's ballot item selections; and (3) printing a document that is acceptable to the electoral jurisdiction of the voter (as a ballot for casting and counting in an election), including all and only the confirmed ballot choices of the voter.

In some embodiments, the initial action with a DRE or BMD is to provide a precinct identifier or ballot identifier for a ballot that a voter wishes to mark.

In some embodiments, the main DRE or BMD usage process may include presentation of ballot options, recording of user selections, and optionally confirming selections before finalizing the selection process.

In some embodiments, at the end of the main BMD process, the BMD system creates a ballot that records choices made by the voter. The ballot may take any of several forms, such as a downloadable and printable document formatted properly for optical scan counting; a printable image; a set of plain text representing choices; a document of plain text in an OCR friendly format; a barcode, QR code, or similar code that represents the selections; or multiple of these formulations.

For in-person voting, there is an important anonymity property of the process of making selections and casting a ballot for both DBM and hand-marking of pre-printed paper ballots. Ballot anonymity means that once cast, a ballot cannot be linked with high confidence to a specific voter. For in-person voting, the process visibly (to the voter and observers) provides anonymity because the check-in process and the ballot casting process are separate. The check-in process involves identifying the voter to determine eligibility to vote, and if eligible, which ballot the voter is entitled to vote. Once this process is completed, ballot marking is performed separately, and ballot casting is performed without any further identification of the voter.

In some embodiments, after marking a ballot in person, a voter may be offered the ability to simultaneously cast the ballot and have it machine-counted in the voter's presence. This also enables the counting machine to pre-check the ballot and identify any potential defects or issues that the voter may wish to correct before casting the ballot.

Remote voting is the process of marking a ballot (e.g., an absentee ballot), filling out an affidavit (attesting to the identity of the person marking the ballot), and sending the ballot and the affidavit to the election office for the jurisdiction that the voter resides in. A typical all-paper remote voting process is often called vote by mail (VBM), in which a pre-printed blank ballot and an affidavit are mailed from an election office to a voter, who completes both and mails them back.

Digital ballot marking (DBM) can also be used for remote voting when a voter is not required to vote in person. The voter can prepare a ballot wherever she chooses, and return the marked ballot to the appropriate election jurisdiction, along with a document called an “absentee voter affidavit” in which the voter self-identifies, and attests to identity and eligibility to vote. Eligibility checks and the preservation of anonymity can be accomplished in a variety of methods, such as, for example, a double-envelope method for postal return of marked absentee ballots and affidavits. In the double-envelope method, the ballot may be enclosed in one envelope, which is then enclosed in an outer envelope along with the affidavit. Election officials determine eligibility based on the affidavit. Once the eligibility is verified, the inner envelope can be separated from the affidavit and stored in the envelope for later counting.

In some situations, the DBM process, when implemented using networked hardware and software, may be performed in a way that does not visibly provide anonymity. In such embodiments, a voter interacts with a DBM system to self-identify in order to determine the correct ballot to be presented to the voter via a user interface implemented in hardware and software. After determining the correct ballot, the DBM system presents the ballot to the voter. While the underlying system may or may not endeavor to record ballot selections without recording the voter's identity, the anonymity of the actual recording is not evident to the voter. Further, even if the DBM system does not try to link ballot selections to identity, the user session may become visible to the computer operators who administer the DBM system; if the operators or intruders with operator privileges elevate their access rights sufficiently, they can view and record the details of a user session independent of the software on the DBM system.

The present disclosure describes a method for the DBM to preserve voter anonymity, which may be extended to preserve voter anonymity in the digital return of a DBM-created ballot.

In a web-based embodiment of the DBM method, there can be multiple components: (1) a user's computer running a web browser; (2) a network linking the user's computer to a DBM system; (3) a DBM system including a web server, a web user interface, and back-end functions that may be either integrated with the web components, or separately implemented as a distinct system that treats the web interface as a client of a DBM service; and (4) a data component of the DBM system recording the details of each a ballot and, for each ballot, the jurisdiction(s) within which voters are entitled to use that ballot.

The DBM system can also have alternative embodiments, such as using a mobile device with a mobile browser, a mobile device with a native client app, or a non-mobile computer with a native client application in a DBM client/server application. The disclosed techniques are applicable to these alternative embodiments. Separate from the DBM system is a public facility for anyone to determine, based on an address, which voting jurisdiction (or a precinct, or in some cases a precinct-split) includes voters registered at that address. The facility need not be digital. It could be a physical publication or a telephone hotline for people to call. A user may state an address, and learn whether that address is a valid voter registration address, and if so, what precinct it is in. The identifier for the precinct (or one of several alternative identifiers) may be anything that can uniquely identify the precinct (or precinct-split), such as, for example, a U.S. Federal Information Processing Standards (FIPS) unique numeric identifier for a vote tallying district; an ordinal number combined with a county and state name (e.g., CA San Mateo County Precinct 42); or a more readily recollected name (e.g., CA San Mateo Middlefield Road Firehouse). A government organization could operate such a service. Other entities may also provide the service based on government provided information, such as information available through the Voting Information Project, to enable a user to provide an address (or current mobile location) and receive polling place information.

In some embodiments, a DBM system need not identify a user, and can visibly operate without knowledge of a user's identity or other personal information. Voters can determine which precinct they vote in by separate services, and accurately convey that information to a DBM system. A DBM system would thus only produce the ballot based on the information provided by the voters. The voters may also use separate services to create absentee voter affidavits, combine it with the DBM ballots, and convey both to the appropriate election jurisdictions. In some embodiments, election organizations and election officials may provide offline or online assistance for these ancillary matters.

A DBM system may be one means for implementing the process described below. Other means for implementing the process are also contemplated.

In some embodiments, a voter first uses a service independent from the DBM to determine whether they are eligible to vote and which precinct (or similar administrative division) that they are entitled to vote in. Such service, including a government-operated voter information services portal, can provide any combination of the forms of precinct identifier discussed above.

In some embodiments, instead of receiving a precinct identifier, a voter may receive a ballot identifier, a unique name of a specific ballot, for example, “CA San Mateo County Precinct 42 Libertarian Ballot for November X, 20XX Primary Election.” In some embodiments, the voter may be presented a choice of several ballots in jurisdictions where party primaries allow for “crossover” votes.

The DBM system may be implemented as a web application embodiment (e.g., via management system 104), and a voter may use a web browser to access a DBM service. The DBM service may be operated by a government organization. The government organization may also publish data for each ballot, such as the unique identifier of the ballot and the ballot's contents, and independent organizations may use the government-provided data in a DBM service for voters.

In some embodiments, the voter may use a web browser and anonymizing web proxy services such as, for example, Tor, to ensure that the DBM system cannot gain user-attributable data about the voter from the network layer of the voter/DBM-system interchange.

A ballot produced by the DBM system includes the voter's selections. The ballot contains no information identifying the user, and the DBM process takes place without the inclusion of information identifying the user.

Once a DBM ballot is complete, it is the voter's responsibility to cast it using the methods supported by the applicable election jurisdiction. This responsibility may be the same as in pure paper postal absentee voting, where, after marking a paper absentee ballot, the voter fills out an affidavit, performs double-enveloping, and uses the correct mailing address to return the ballot.

In an extended embodiment of the anonymous DBM process, a voter can make use of online services provided by state and/or local election officials. These services are described below as being provided by a single online service (e.g., management system 104), but they could also be provided by a number of disparate services or informational web sites, with varying degrees of coordination or integration. The extended process includes three actions described below.

A first action, where users use the management system 104, may be done anonymously or not, without compromising ballot anonymity. In some embodiments, the voter uses the management system 104 to anonymously provide the registration address and receive data specific to that address, including (1) the precinct or ballot identifier for that address in each upcoming election; (2) information about separate or independent DBM service(s) that can assist the voter in preparing an anonymous marked ballot in a format acceptable for the election jurisdiction of the provided address; (3) information about acceptable ballots such as, for example, a “Federal Absentee Write-In” ballot, a simple document format that is acceptable as a ballot for some classes of voters; (4) information about the absentee voter affidavit required, and a link to a downloadable blank affidavit; and (5) information about options and requirements for the return of the ballot and the affidavit.

In some embodiments, a previously registered voter uses the management system 104, beginning with identification and authentication to initiate a management system 104 session for the particular previously registered voter. The voter may obtain information such as: (1) the precinct or ballot identifier for the voter's address in each upcoming election; (2) a downloadable document that is a pre-filled absentee voter affidavit with data drawn from the voter's record, combined with any additional information that the voter may optionally provide at the management system 104 prompting; (3) information about separate or independent DBM service(s) that can assist the voter in preparing an anonymous marked ballot in a format acceptable for the election jurisdiction of the provided address; (4) information about acceptable ballots such as, for example, a “Federal Absentee Write-In” ballot; and (5) information about options and requirements for the return of the ballot and the affidavit.

In a second action, in some embodiments, the voter may use an online service selected from a set of services to perform the DBM, typically but not necessarily using a DBM service that is listed by the management system 104 as producing DBM ballots in an acceptable format.

In a third action, in some embodiments, the voter completes the affidavit by filling in form fields not pre-filled and providing signature if required. The voter then combines the affidavit and ballot and returns the combined absentee packet per instructions from the management system 104.

Once a DBM ballot is complete, it is the user's responsibility to cast it using methods supported by the election jurisdiction.

In some embodiments, in an extension of the DBM process, the DBM system can accommodate the digital return of ballots in addition to digital marking, but may not preserve anonymity. In such embodiments, the management system 104 session can be amended to include the ability for the user to provide to the system a digital facsimile (or other digital format) of both the marked ballot and the completed affidavit. In some embodiments, the management system 104 session can forgo the affidavit with attestations provided interactively during a management system 104 session. This approach may not preserve anonymity because the upload or other form of transmission of the ballot is conducted in an online session that includes the identification of the user.

In some embodiments, an anonymity preserving extension may be implemented, such as by adding the following capabilities. (1) The publication by an election organization of information that enables a voter to create a private version of a digitally marked ballot. Such publication may include the public component of an asymmetric cryptographic key intended for use with a standard public-key cryptographic technique to encrypt or “digitally envelope” a ballot. (2) The use of an independent service that can provide a user with a ballot document and information described in item (1) above, and create for the user the digitally-enveloped ballot. (3) The ability of an election organization to digitally receive such digitally-enveloped ballots in conjunction with a digital affidavit document as a form of ballot return. With these additional features, an election organization may be able to conduct an absentee ballot verification process that is completely analogous to the paper double-envelope method described above for preserving anonymity of absentee or vote-by-mail ballots. In some embodiments, an extended process for preserving anonymity of a digital ballot may include the following actions.

A first action can be done either anonymously or not, without compromising ballot anonymity.

In some embodiments, the voter uses the management system 104 to anonymously provide registration address, and receive data specific to that address, including (1) the precinct or ballot identifier for that address in each upcoming election; (2) information about separate or independent DBM service(s) that can assist the voter in preparing an anonymously marked ballot in a format acceptable for the election jurisdiction of the provided address; (3) information about acceptable ballots such as, for example, “Federal Absentee Write-In” ballot; (4) information about an absentee voter affidavit required, and a link to a downloadable blank affidavit; (5) information about options and requirements for the return of the ballot and the affidavit; and (6) information about acceptable forms of digital envelope.

In some embodiments, a previously registered voter uses the management system 104, beginning with identification and authentication to initiate a management system 104 session for the particular previously registered voter. The voter may obtain the following specific information: (1) the precinct or ballot identifier for the voter's address in each upcoming election; (2) a downloadable document that is a pre-filled absentee voter affidavit with data drawn from the voter's record, combined with any additional information that the voter may optionally provide at the management system 104 prompting; (3) information about separate or independent DBM service(s) that can assist the voter in preparing an anonymously marked ballot in a format acceptable for the election jurisdiction of the provided address; (4) information about acceptable ballots such as, for example, “Federal Absentee Write-In” ballot; (5) information about options and requirements for the return of the ballot and the affidavit; and (6) information about acceptable forms of digital envelope.

In a second action, in some embodiments, a voter uses an online service to perform the DBM, typically but not necessarily using a DBM service that is listed by the management system 104 as producing DBM ballots in an acceptable format.

In a third action, in some embodiments, the voter uses an enveloping service to receive a digitally enveloped ballot and a ballot document. The service may include (1) a completely general stand-alone service online; (2) a specific optional feature of a DBM service; (3) a service operated by an election organization independent of a management system 104, with no requirement for user authentication or identification; and (4) a service local to the computer used by the voter for the DBM, which uses local tools for performing standard cryptographic operations.

The voter can then convey the digital affidavit and the digitally enveloped ballot to an appropriate election organization, as directed by the information from the management system 104, for ballot casting.

Such embodiment enables the preservation of anonymity but may not preserve the integrity of the ballot because the voter makes choices about what, who, and how to trust with the digital enveloping process, and about how to obtain legitimate cryptographic key data from the election organization. With poor choices because of inaccurate information or fraud, the enveloped ballot might not contain an accurate rendition of the original ballot, or might not be readable by the election organization.

One or more aspects of the embodiments described with respect to digital voting may be implemented remotely. In some embodiments, an optimization of VBM involves digital blank ballot distribution, in which the ballot and affidavit are emailed to or downloaded by the voter, printed locally, completed and mailed back. Another optimization of VBM is the digital return, in which the marked ballot and completed affidavit are scanned, and the scanned images are returned electronically to the election office, in lieu of the paper documents. In another embodiment of remote voting, there is no affidavit or ballot per se. Rather, a voter interacts with an automated system such as a web application, a telephone keypad or an audio system to (1) self-identify in lieu of an affidavit; (2) be presented with ballot items and corresponding choices; (3) indicate a choice(s) for each ballot item; and (4) have the choices directly recorded in lieu of an actual ballot.

Paper ballots may be counted by hand, or by automated techniques, such as techniques that rely on scanning of paper ballots to find marks made by voters. These techniques apply to paper ballots cast in person, or paper ballots cast in a vote-by-mail process or similar process. These techniques apply to precinct ballot counting or central ballot counting. Directly recorded in-person voting does not use ballots; rather, each DRE voting machine's vote tallies are used in a later tabulation process.

Before remotely cast ballots can be evaluated, a record of in person voting is assembled during a process of pollbook intake. Pollbook intake re-records each voter check-in that was recorded on a paper or digital pollbook in a consolidated dataset. Such data is typically, but need not be, integrated into a voter records database. In the case of an all-paper-pollbook election, pollbook intake can also be performed in a completely manual process by collecting the paper pollbooks into one place.

After the completion of the pollbook intake, a single voter check-in record can be used in the process of adjudicating absentee ballots and provisional ballots. The adjudication is the process of deciding whether to count such a ballot based on a number of factors, including: (1) examining the ballot's affidavit to identify the ballot's voter; (2) looking up the voter in the voter check-in records; (3) skipping the ballot if the records show that the voter checked in in-person, or if the records show that a ballot not cast in-person was already counted for the voter.

If the affidavit/ballot pair passes this and other checks, the voter check-in records are updated to record that this voter has a ballot not cast in-person that is eligible for counting; the affidavit and the ballot are separated; and the ballot is set aside for counting.

Machine counting of completed ballots may be used in election scenarios with a large number of voters or long ballots that are not feasible for timely and accurate ballot counting by hand. Many machine counting approaches use mark-sense optical scanning or digital image processing of previously captured digital images of a paper ballot. Most ballot counters in common use are proprietary products that implement a single proprietary approach to scan and interpret ballots based on a ballot design and layout process that was previously performed with proprietary ballot preparation products from the same vendor as the scanner. Consequently, current practice in nearly all U.S. election jurisdictions is the use of ballot counting devices that can handle ballots in a single supported format or variations on a single format, for example, different paper sizes.

These single-format ballot counting methods often rely on pre-defined format(s) for pre-printed ballots, such as a format based on a flat grid of “mark zones” defined by the intersection of rows and columns defined by “timing marks” that the scanner uses to define the grid. This method is referred to as pre-provisioned grid-based mark scanning. A counting device is typically pre-provisioned with data that defines each mark zone as unused or denoting a vote for a particular candidate or ballot measure response. Because multiple distinct ballots may be used in an election, there is a mark-zone dataset tied to each particular ballot style. Each ballot style has a machine-readable identifier, such as, for example, a bar-code or optical-character-recognition text in a particular page location defined by the timing marks. Any ballot that lacks properly placed timing marks or ballot-style identifier cannot be automatically scanned.

In many election jurisdictions, there are typically several different formats of ballots used, with only one format actually capable of being machine-counted. Examples of different formats are: (1) the Federal Write-In Absentee Ballot (FWAB), a federally mandated ballot format for a class of voters called Uniformed and Overseas Citizens Absentee Voting Act (UOCAVA) voters; (2) the Oregon Alternative Format Ballot (AFB), intended for use by handicapped or home bound voters, and produced by ballot marking software available via a web application or a mobile voting booth with similar digital ballot marking software; (3) ballots created by military and overseas voters using digital blank ballot distribution services, home printing of a downloaded ballot, and hand marking of the ballot; and (4) ballots created by military and overseas voters using digital ballot marking service, home printing of a marked ballot, and optional addition of other hand-marks to the printed ballot.

In each of these cases, the ballot produced may fail to meet the format required by the ballot counting device in use in the voter's electoral jurisdiction. For these ballots to be counted, election officials perform either hand-count or transcription to a blank pre-printed machine-count ballot. State election laws govern which process is used, and what measures are required for accountability and repeatability of ballot counts, records of transcription, and so forth. These methods may be burdensome to election officials, and introduce human errors that are not present in machine counting.

The present disclosure describes a number of hardware and software enabled processes for machine counting of multiple formats of ballot by a single device, as well as a number of variations on these processes and how they use computing technology in ways that are consistent with existing U.S. election administration practice. Included in these variations are not only support for multiple formats of ballots in a single ballot counting device, but also multiple techniques of image capture and processing, and multiple techniques of storing the captured data.

Tabulation may occur after every ballot has been counted. However, preliminary tabulation can often be performed on an incomplete set of ballots. In some embodiments, each running of a counting device produces intermediate vote-count data for a set of ballots, which are referred to as “tallies.” In many cases, many tallies fall into the category of those derived from one run of a counting device on ballots from one precinct cast in person. However, there is no requirement that an individual tally dataset corresponds to one precinct or one voting method. In the process of defining an election and the data for it (e.g. the JED) one required element is the expected set of precincts that report tallies. In the described embodiments the system is configured to exclude any tallies that come from one of a configured group of precincts.

An additional optional element is an expected set of tallies. Typically number of tallies from a precinct, and these tallies may come in different types: a tally from a precinct count machine in use on election day in given precinct; a tally from a central count machine counting absentee (or provisional) ballots for a given precinct; a tally from a central count machine counting absentee (or provisional) ballots from multiple precincts.

The present system enables an automated reconciliation. It compares (a) the expected tallies part of the election administrative configuration of precincts data previously established (b) the set of meta-data about all the tallies being tabulated.

Some common reconciliation errors (there are others) are: a tally from an unknown precinct or vote tallying unit or district; an expected tally missing, e.g. no absentee tally for one precinct; an unexpected tally, e.g. a 3rd tally where we expected only 2 tallies from an election day precinct counting device.

Tabulation is the process of aggregating the tally datasets, and adding the vote counts together to create vote totals for ballot items in the election. Typical but not required is a manual or automated reconciliation of expected tallies and actual tallies on hand for tabulation.

After the conclusion of an election, reporting of metrics and statistics may be performed. Interim reports during an election cycle are also possible.

The reporting of election results may focus on votes per candidate or referendum choice, but may sometimes include residual votes (under/over) or registration statistics. The lowest level of recording is usually an individual precinct. Reporting may be stratified by ‘voting channel’ (also called ‘ballot type’ or ‘voting method’), such as in-person voting, provisional voting, absentee voting, and early voting.

The reporting on participation may compare voter turnout to registration, either in aggregate or stratified by reporting unit.

There may also be reporting on performance or demographics. Minimal performance reporting may include statistics on absentee ballots vs. absentee ballots counted. Provisional ballots can also be reported in order to assess how an election administration performs in enabling voting. Demographic reporting can be derived from voter records. Many other reports may be generated in addition to those described.

In the context of election reporting, analytics is a broad term applied to analysis or reporting of combinations of data. It is typically done at least to the extent required by Federal agencies such as Election Assistance Commission and Federal Voting Assistance Program.

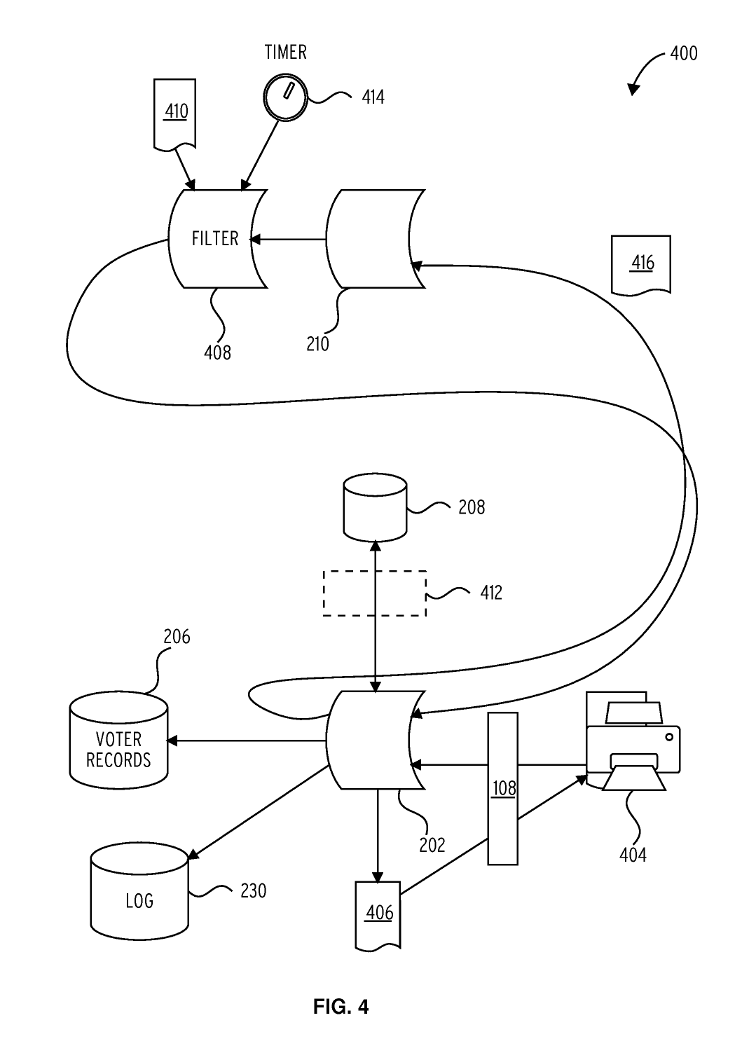

FIG. 4 illustrates an embodiment of a voter registration system 400. The voter module 202 receives voter credentials 416, e.g. electronic credential resulting from an optical scan by a printer/scanner 404 operated by the voter terminal device 108, and operates other components of the election system 200 to perform a voter certification process. The voter credentials 416 are applied by the voter module 202 to the administrator module 210, which operates an eligibility filter 408 on the voter credentials 416 as configured by configured filter settings 410 and a timer 414. The configured filter settings 410 and timer 414 cause the eligibility filter 408 to operate to transform the voter credentials 416 into a certification signal to the voter module 202 only if the voter credentials 416 are consistent with a voter who is eligible to vote (e.g., not an incarcerated felon) in a particular election, and if the registration request is consistent with a time period for registering for the election.

The voter module 202 may interoperate with the external associator 208 via hash transformer 412 for the external associator 208 in order to carry out the registration process in conjunction with the administrator module 210.

A successful voter registration may cause the voter module 202 to operate the voting associator 206 to add the voter to the configured voter rolls for a particular jurisdiction and/or election. The transaction log 230 may likewise be operated by the voter module 202 to record the registration transaction. The voter module 202 may generate a structured registration confirmation 406 and communicate the structured registration confirmation 406 to the voter terminal device 108, which may operate the printer/scanner 404 to render a printout of the structured registration confirmation 406.

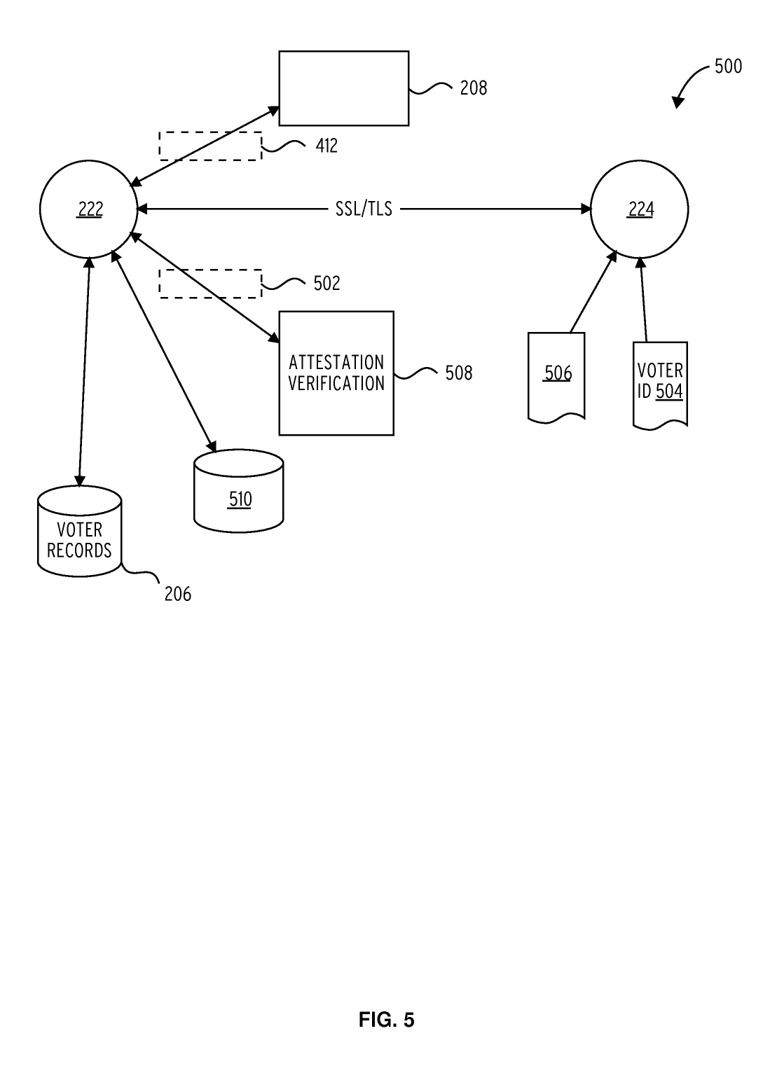

FIG. 5 illustrates an embodiment of a voter authentication system 500. The voter authenticator 222 communicates a voter id 506 and/or a structured attestation document 508 to the voter authenticator 222 via a secure channel 226 using, for example, Secure Socket Layer (SSL) or TLS.

The voter authenticator 222 may engage the external associator 208 via the hash transformer 412 to determine voter attributes such as, for example, the voter's legal name, address, and social security number. The structured attestation document 508 may be communicated by the voter authenticator 222 to an attestation verification 510 system via a hash transformer 502.

The voter authenticator 222 may interoperate with one or more other associator 514 to authenticate the voter. Upon authenticating the voter, the voter authenticator 222 may operate to update the voting associator 206 to add the voter to voting rolls for a voting district and/or particular election.

A management system 104 is typically operated by or on behalf of a government entity that maintains voter rolls as a part of the election administration. The voter rolls are based on voter registration in most U.S. states, or voter attestation in states such as North Dakota.

A management system 104 user session may begin with identification and/or authentication (I & A). In some embodiments, the I & A uses a strong authentication method that was previously set up between a government entity and a citizen. For example, the authentication may be done using a smart-card government identification card, a U.S. military common access card (CAC card), a commercial solution such as SecurID, or an exchange using public-key-infrastructure to authenticate the user including but not limited to the use of secure sockets layer (SSL) or Transport layer security (TLS) with a client certificate.

In some embodiments, the I & A uses a voter authenticator 222 operating in cooperation with a third party authentication service that is trusted by the government entity operating the management system 104. Such a service may be anything of a similar nature to currently available services of Facebook or Google, or other services using similar technologies, including but not limited to OAuth or Kerberos.

In some embodiments, absent a government's ability to truly authenticate a user, the I & A may include requiring a user to attest to being a particular registered voter, and supplying sufficient person identifying information (PII) to satisfy state-specific requirements for access to voter information. For example, in the Commonwealth of Virginia, a paper-based voter application requires the user to provide name, locality, date-of-birth (DOB), and an identification number. Examples of the identification number include social security number (SSN), SSN4, driver's license number, or state ID card number (DLN). Generally, the identification number must match current records for the application to be approved. Likewise, the VISP for Virginia requires the user to provide a similar set of PII in order to gain access to voter records in a VISP session.

In some embodiments, the PII is compared with stored data that is a part of the voting associator 206. In some embodiments, the PII is “hashed” and compared with stored hash data that is also a part of the voting associator 206. A “hash” is a technique of combining various data into a single data entity, where the hash value is unique to the input data, and the hash does not expose the input data to view. In some embodiments, the hash technique can be a cryptographic hash function, such as secure hash algorithm (e.g., SHA-1, SHA-2, SHA-3), or message-digest (e.g., MD4 or MD5).

In some embodiments, the PII is sent to an independent service, which compares the PII with stored data that is a part of the independent service, or hashes the PII and compares the hash value with stored hash data. The independent service may be a separately controlled data warehouse for voter records, or a single-purpose identification service. Both hashed and unhashed forms of data storage and lookup may include, but are not limited to, the use of a conventional database management system.

In some embodiments, the PII is hashed first, and the hashed PII is sent to an independent service, which compares the hashed PII with stored hash data.

In each of the above embodiments involving an independent service, the lookup request and response may be messages encrypted using data security methods. In some embodiments, the exchange is through a session encrypted using communication security methods. In some embodiments, the exchange is not encrypted.

In some embodiments, the I & A uses a reusable shared secret, including but not limited to a password, pass-phrase or correct answers to security questions previously established during an account creation process. During account creation, a user may provide a sufficient set of PII to support an attestation of identity, similar to the “Identification” process described above. Thereafter, a user identifier and the shared secret can be used to begin a management system 104 session. The user identifier may be any unique part of the PII, such as the SSN or DLN, or an identifier defined as a part of the registration process.

In some embodiments, various methods involving data managed by the management system 104 or a separate managing entity may be used to check the user identifier and the shared secret.

In some embodiments, voter id 504 and structured attestation document 506 can be represented by different fields in a user data stream, such as fields for the last name, the first name, the year of birth, the month of birth, and the date of birth of the voter. In some embodiments, the voter id 504 and structured attestation document 506 can be represented by a data structure with multiple field names and field data, where the field name may include, for example, the last name, the first name, the year of birth, the month of birth, and the date of birth.

In some embodiments, the voter id 504 and structured attestation document 506 is transported or stored in an extensible markup language (XML). The XML is designed to store and transport data or information, which can be read both by people and by machines. The XML can serve as a bridge between different data structures of different software applications. Each application's data structure can be mapped to an agreed-upon XML structure such that the applications share data in this XML format. By knowing two data structures, its own and the XML structure, each application is able to share data with many other applications.

The XML separates data content from data formatting. An XML document does not specify how the content should be displayed. Rather, the formatting is left up to an external style sheet. The XML can store highly structured data, such as data stored in databases or spreadsheets, or loosely structured data, such as data stored in letters or manuals. The XML content can be transformed to HTML for display on a web page, to Word document format, to PowerPoint slide format, to plain text, or to audio format.

The voter id 504 and structured attestation document 506 requirements may vary from jurisdiction to jurisdiction. In some embodiments, the work flow of the management system 104 is adaptable to accommodate requirements of different jurisdictions.

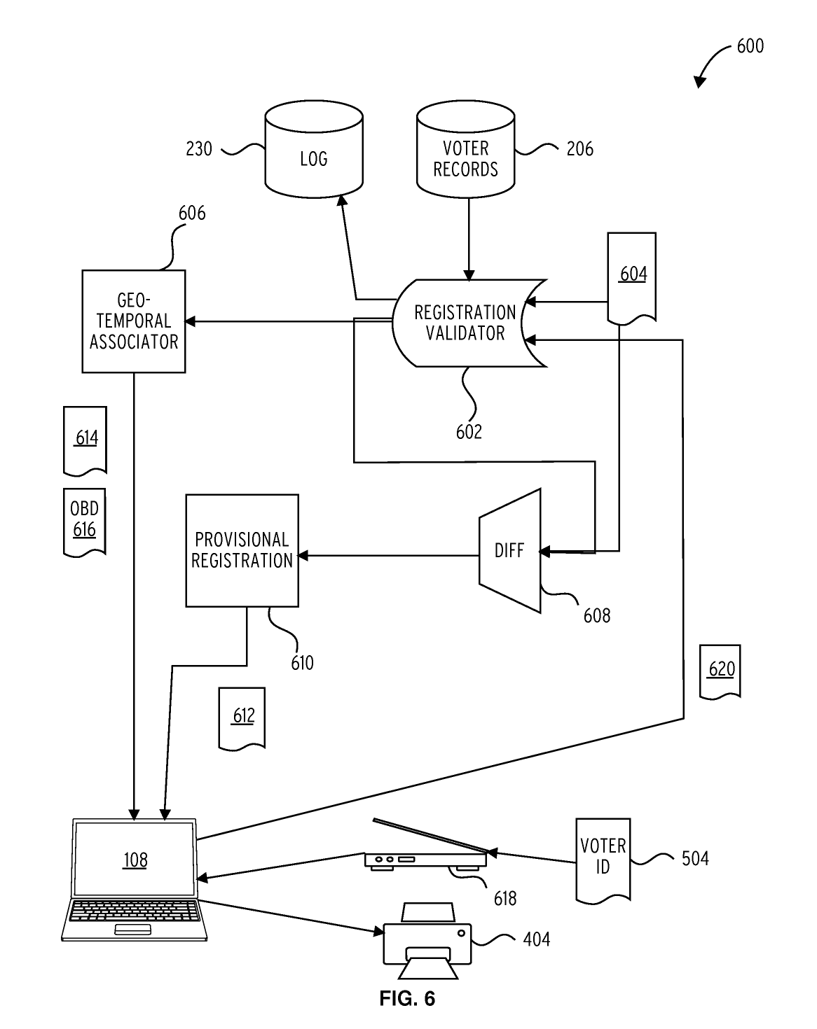

FIG. 6 illustrates an embodiment of a voter registration validation system 600. The voter terminal device 108 operates a scanner 618 to digitize a voter id 506 (e.g., driver's license, passport, voter id card, etc) to produce an electronic voter credential 620. The electronic voter credential 620 is communicated to the registration validator 602 which operates on the electronic voter credential 620 as influenced by configured validation rules 604, for example as described in FIG. 5.

Requirements for a valid voter registration and the configured validation rules 604 may be applied to a difference generator 608 to produce a set of qualification parameters required to complete the voter registration. These qualification parameters may be communicated to the voter terminal device 108 in the form of a provisional ballot 612 generated by a provisional registration 610 system. If there is insufficient qualification for even the provisional ballot 612, the difference generator 608 may communicate a registration error report to the voter terminal device 108 indicating procedures that may be taken to remediate the failed registration process.

The registration validator 602 may operate a geo-temporal associator 606 to identify a polling place for the voter, for example based on a voter residence address in the electronic voter credential 620. The geo-temporal associator 606 may generate a voter registration form 614 and/or an onboarding document 616 for the voter, and communicate these to the voter terminal device 108. The voter terminal device 108 may operate the printer/scanner 404 to print the voter registration form 614 or onboarding document 616, or may save them electronically or on a mobile device of the voter (not shown).

Election officials may access the management system 104 to process the voter registration request, and create election specific voter rolls in the process of preparing for an election.

Once registered, a voter may also access part or all of that voter's record as stored in the voting associator 206 such as checking registration records, updating status, requesting a voter registration card, checking eligibility of an online ballot, and requesting an absentee ballot.

A registered voter can check a registration record online. Following a management system 104 session initiation and user login, for example, the management system 104 can present the user with a variety of data from the voting associator 206. The data itself can be a part of the voting associator 206, or derived from a separate managing entity, similar to that described with respect to the I & A. In some embodiments, the management system 104 may use a separate back-end system to look up and provide the information on a session-by-session basis through a strongly authenticated private communication channel.

In some embodiments, the voter record includes whether a voter registration is current, or has a flagged status. The kinds of flagged status vary in number and nature from jurisdiction to jurisdiction, but share the common characteristics that some additional action(s) may be necessary before the voter can vote in the current election. If there are no flags, the voter is currently registered and is able to check in at an appropriate polling place.

In some embodiments, the voter record also includes the options available for the voter to vote, such as dates, times and locations where they are eligible to vote, and web links to maps or directions. These options may vary from jurisdiction to jurisdiction, and may include: an election day polling place for the voter's precinct; an election day voting center for the voter's precinct and other precincts; early voting centers; the local election administration office as a back-up polling place for precincts; and information about the upcoming election being an all-vote-by-mail election with no in-person voting option.

In some embodiments, if the voter registration is current, the voter record may include what other actions may be involved in order to vote in person, which also varies by jurisdiction but may include, for example, presenting a state photo-ID to validate identity, or preparing to attest to the identity with a signature.

In some embodiments, if the voter's registration is flagged, the voter record may include the voter's voting options, and what other actions may be required. In some embodiments, the voting associator 206 includes pending status due to the lack of a current voter signature, which can be remedied by re-registering to vote before a voter registration deadline of the upcoming election. Lacking re-registration, the voter may also vote provisionally. A provisional voting is a vote by a voter when there are questions about the voter's eligibility. For example, provisional voting may be done when the voter refuses to show a photo ID in jurisdiction that require one, when the voter's name does not appear on the electoral roll for the given precinct, when the voter's registration contains inaccurate or outdated information such as a wrong address or a misspelled name, or when the voter's ballot has already been recorded. Whether a provisional vote will be counted is contingent upon the verification of that voter's eligibility, among other factors contingent on state and federal election law.

In some embodiments, the voting associator 206 may include inactive status if the voter is on record as incarcerated or on parole from a felony conviction, which may be remedied by re-registration with appropriate documentation of re-instatement of eligibility in some jurisdictions.

In some embodiments, in jurisdictions that allow an initial voter registration to not include a copy of an acceptable ID, the voting associator 206 may indicate a pending status, which requires that the voter presents an ID and provides a signature in the check-in process.

In some embodiments, a voter may also enter enough personal information to look up a voter record in the voting associator 206, to confirm that the voter is registered, and optionally to provide other information. Some examples will be described below.

In some embodiments, the voter may be alerted of the parts of the voter record to be updated, such as the name and address if they are out of date. In some embodiments, if some information is out of date, a voter can use the management system 104 to update registration information or re-register using all-paper, all-online, or mixed approaches similar to those described above.

A registration update in some jurisdictions may include changing voter status. A voter status may include, for example, an on-going in-person voter, an on-going absentee voter, an in-person voter for the upcoming election only, and an absentee voter for the upcoming election only.

In some embodiments, the registration update in some jurisdictions may also include the submission of a separate “absentee ballot request” form.

In the case of a fully active voter with no flags on record, the user in a management system 104 session may request the management system 104 to prepare an on-boarding document (onboarding document 616—‘OBD’), which is a document that includes: (1) information that will be useful on election day, for example, polling place location and maps; (2) information to be used by a poll worker during check-in, for example, readily identifiable voter name address and status, to save the time and avoid potential confusion for verbal conveyance of this information during the check-in process; (3) information intended for automated consumption by a digital pollbook (DPB) or other form of electronic pollbook, including but not limited to the voter's voter ID number, name, and address encoded in a machine readable form including but not limited to the bar-code, the QR-code, or a font convenient for optical character recognition. The term “pre-check process” is used below to describe the activity in which a voter determines that they are eligible to vote in person, and optionally obtains an OBD to facilitate the in-person check-in process.

Aside from being a handy reference for the voter, the OBD may also facilitate a rapid check-in of the voter if the polling place is equipped with a DPB or other forms of electronic pollbook that can read the machine-readable component of the OBD.

In some embodiments, a management system 104 generated OBD can take the form of a document intended for user downloading and printing, or direct printing in the case of a management system 104 web application. An OBD can also be a digital image in any standard form suitable for downloading and copying to a mobile device, such as a laptop, a tablet, a smart phone, or a wearable device. The management system 104 can also offer an online service to send the digital OBD directly to the user's mobile device.

In some embodiments, if a voter is not fully active and/or has flags as noted above, the management system 104 can provide an OBD that describes the user's particular situation in detail, as appropriate for use in a polling place, and can assist the user in preparing other documents, including but not limited to a complete and correct provisional voting affidavit to be presented during voter check-in as required by the voter's status. In the provisional voting affidavit, a voter self-identifies, and attests to identity and eligibility to vote. In such case, the OBD, in addition to the use described above, serves to convey to the poll workers both the exact situation of the voter, and the fact that the voter has already prepared the appropriate supplemental materials.

In some embodiments, another use of management system 104 is when a user fails the I & A for reasons such as that she has not in fact registered to vote. In such case, the management system 104 can assist the user in registering to vote by, for example, generating an election-day voter registration application and provisional affidavit in states with election laws that support such practices.

In some embodiments, for voters that are approved as absentee voters in an upcoming election, there may be additional actions of preparation related to an absentee ballot (AB). These actions can be undertaken using similar types of all-paper, all-online, or mixed approaches described above. These actions may include (1) checking absentee eligibility status, or requesting a change to the absentee status; (2) providing information about how the absentee ballot kit, typically an affidavit and a blank ballot, is to be provided to the voter; and (3) directly obtaining a printable AB kit from a management system 104 through digital blank ballot distribution (DBBD), receiving a paper AB kit via postal service or similar carriers, or receiving a printable AB kit via email.

In the case of paper ballot, the voter can further prepare to vote by filling out the affidavit form and marking the ballot, as a final preparation for casting the ballot.

In the case of DBBD, the voter may also interact with a digital form of the ballot to gain assistance for a complete, correct, and legible marking of a software created ballot document and/or the affidavit. These documents may be printed and prepared for casting physically, or saved for casting digitally. In some embodiments, the affidavit may be printed and signed with a hand-inked signature. In some embodiments, the ballot may contain machine-readable voter choices, such as, for example, a bar-code or similar codes, or may be expressed in an OCR friendly format.

In the election preparation process, the LEOs' work may also include the management of the voter roll as a whole. A voter roll is used to generate a list of voters for each pollbook. The pollbook is consulted such that no voter may have more than one ballot counted. Therefore, creation of a complete and accurate voter roll is desirable, and is generally a goal of voter roll management. By way of example, valid voter registration requests must be entered, and dead or otherwise ineligible voters flagged or removed from the voter roll.

Because voter roll creation must be completed before election day, there is generally a deadline for the processing of voter requests, after which the voter request, even if approved, will not affect the voter rolls used in the current election.

In many voter registration states, the registration deadline is explicit. Requests after a certain date may not be processed until after the upcoming election; and if the processing of the requests would be required for a voter to vote in the upcoming election, then that voter may not be eligible to vote. Even though a voting place's voter roll or pollbook can be extended at voting time to include new voters through, for example, same day registration or affidavit-based access rather than registration, the check off function is greatly assisted by having a pre-prepared voter list that contains most of the voters who will vote in the election.

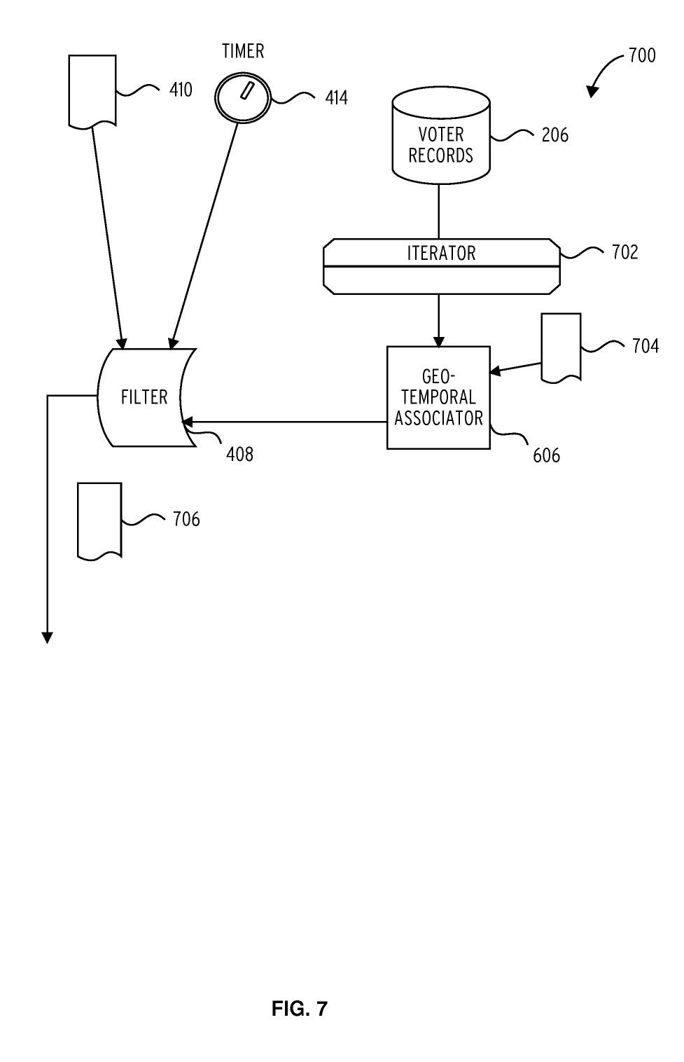

FIG. 7 illustrates an embodiment of a pollbook generation system 700. An iterator 702 operates on the voting associator 206 to locate voter records. The geo-temporal associator 606 matches each of the voter records to a configured poll place location 704 and an election time period (e.g., an election date and polling times).

Qualified voter records from the geo-temporal associator 606 are applied to the eligibility filter 408, which produces a pollbook 706 for one or more polling locations.

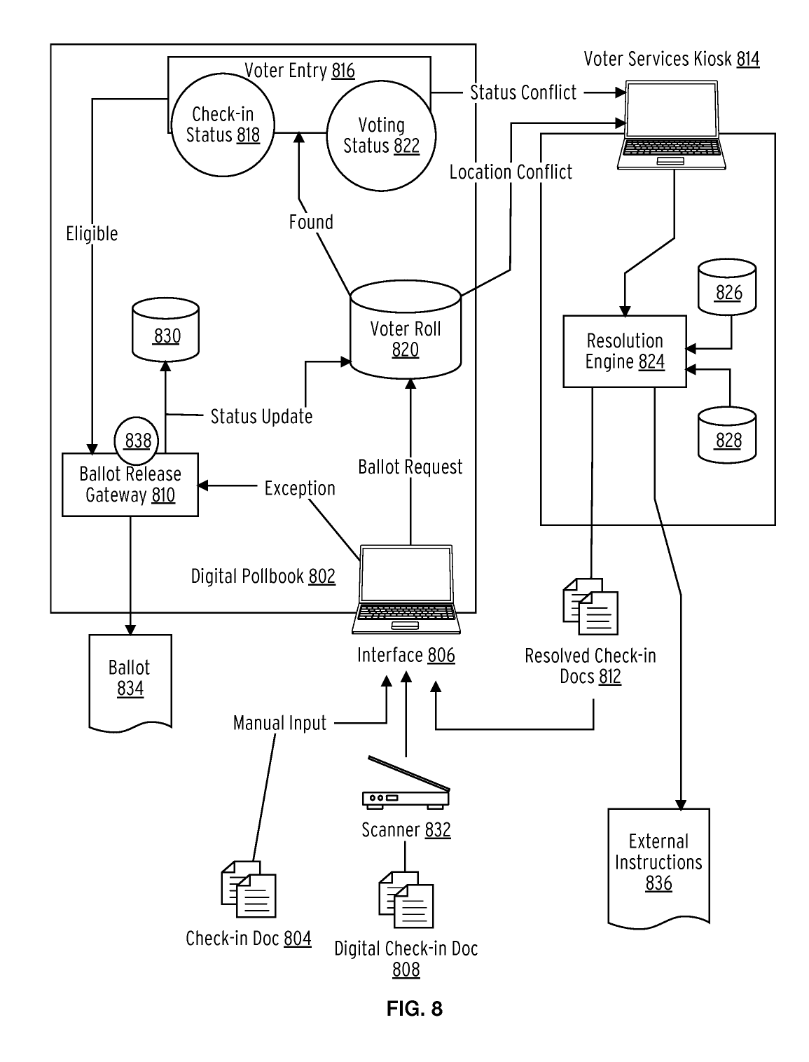

Referencing FIG. 8, the system for controlling ballot access comprises a digital pollbook 802 and a voter service kiosk 814. The digital pollbook 802 functions as a control point for the release of a ballot 834 for to a voter upon verifying their eligibility. The voter service kiosk 814 functions as a way to troubleshoot potential problems preventing an eligible voter from obtaining a ballot 834.

The digital pollbook 802 receives voter check-in documents from potential voters and verifies the voters eligibility prior to releasing a ballot 834. The digital pollbook 802 comprises a digital pollbook interface 806, a voter roll 820, and a ballot release gateway 810. The digital pollbook interface 806 is the interaction point through which an election official or a potential voter submit the voter check-in documents. The voter check-in documents contains information utilized to identify the potential voter within the voter roll 820, such as a voter ID or voter data comprising a voter's full name and address. The voter check-in document is received through the digital pollbook interface 806 in a variety of formats such as a physical voter check-in document 804 and a digital check-in document 808. The digital pollbook interface 806 comprises voter identifiers in the form of a voter's full name, address, or voter ID number as well as combinations thereof, in a machine readable format that is transmitted to the digital pollbook interface 806 through a scanner 832. The physical voter check-in document 804 is a physical document comprising voter identifiers in the form of a voter's full name, address, or voter ID number as well as combinations thereof that is manually entered through the digital pollbook interface 806 by an election official/poll worker. The digital pollbook interface 806 transforms the voter check-in document into a ballot request signal that is transmitted to the voter roll 820 as a query for the voter entry 816 associated with the voter check-in document. It should be noted that the voter identifiers of the voter check-in document is can be used to identify the voter entry 816 in the voter roll 820.

The voter roll 820 is a digital collection of all eligible voters for a particular polling location. The voter roll 820 comprises a plurality of voter entries where each voter entry is associated with an eligible voter for the particular polling location. The voter roll 820 receives the ballot request signal from the digital pollbook interface 806. The ballot request signal initiates a query of the voter roll 820 for a voter entry 816 associated with the voter check-in document.

The querying the voter roll 820 for a voter entry may invoke three common situations, although other situations are also possible: the queried voter entry is not found in the voter roll 820; the queried voter entry is found in the voter roll 820 but detects that the voter has already checked in or has checked in and voted; or the queried voter entry is found in the voter roll 820 and detects that the voter has not checked in.

In the situation where the voter entry associated with the voter check-in document is not found in the voter roll 820, the digital pollbook 802 would determine the absence of the voter entry signify a location conflict. The determination of a location conflict is due to the location specific nature of the voter roll 820 for the particular polling location. In the aforementioned situation, the digital pollbook 802 attempts to resolve the issue by transforming the location conflict into a discrepancy resolution signal to be transferred to a voter service kiosk 814.

In the situation where the voter entry 816 associated with the voter check-in document is found in the voter roll 820 but detects that that the voter has already checked in or has checked in and voted, the digital pollbook 802 would determine the fact that the voter is attempting to vote again, based on submission of the voter check-in document as a status conflict. The determination of a status conflict is based on the ballot access control functionality of the digital pollbook 802 that modifies status switches to denote whether the voter has checked, and whether the voter has been issued a ballot in an attempt to prevent double voting. The voter entry 816 comprises a check-in status switch 818 and a voting status switch 822. Under the aforementioned conditions, the check-in status switch 818 would be found in a closed state, representing that the voter had already checked in, or both the check-in status switch 818 and the voting status switch 822 would be found in the closed state, representing that the voter has already checked in and been issued a ballot. The digital pollbook 802 attempts to resolve the issue by transforming the status conflict into a discrepancy resolution signal to be transferred to a voter service kiosk 814.

In the situation where the voter entry 816 associated with the voter check-in document is found in the voter roll 820 and determined to have not checked in or been issued a ballot, the digital pollbook 802 would transform the open state of the check-in status switch 818 to a closed state as controlled by the ballot request signal. The transformation of the open state of the check-in status switch 818 to the closed state is done as a means of preventing the same voter from attempting to obtain another ballot. It should be noted that the transition of the status from an open state to a closed state occurs concurrently with the transmission of the eligibility signal such that the transition itself could be view as the eligibility signal by the ballot release gateway 810. The transmission of the eligibility signal to the ballot release gateway 810 negotiates the release of a blank ballot 838 through the ballot release gateway 810. The eligibility signal is transformed into a voting status closure signal and ballot release instructions. The ballot release instructions control the release of the blank ballot 838 retained through the ballot release gateway 810. It should be noted that the blank ballot 838, may be provided as a physical ballot or a digital ballot, and that the ballot is considered blank as no votes have been cast on it. Upon release of the blank ballot 838, the ballot release instructions control the transmission of the voting status closure signal to the voter roll and the digital pollbook manager database 830. The voting status closure signal is transmitted to the voter roll 820 and the digital pollbook manager database 830 to modify the open state of the voting status switch 822 of the voter entry 816. The voting status closure signal is responsible for the transition of the voting status switch 822 from the open state to the closed state denoting that the voter associated with the has received their ballot and voted. The voting status closure signal is transmitted to the digital pollbook manager database 830 to ensure that the implications of the closed voting status switch 822 (i.e. the voter has checked in and the voter has received their ballot) is stored in a centralized database that is accessible to all digital pollbooks in communication with the digital pollbook manager database 830. It should be noted that in some embodiments where the digital pollbook 802 lacks a network connection to communicate with the digital pollbook manager database 830, the voting status closure signal would be stored in the memory of the digital pollbook 802 until a connection is established to sync the status change.

The voter service kiosk 814 receives the discrepancy resolution signal generated by the digital pollbook 802. It should be noted that in some embodiments the digital pollbook 802 and the voter service kiosk 814 exist as separate entities, and requires a voter or the election official/poll worker to initiate/re-initiate a resolution process for the voter. Upon initiation of the resolution process, the discrepancy resolution signal is transformed into voter identifiers and discrepancy parameters. The discrepancy parameters are the particular issued that generated the discrepancy resolution signal such as the status conflict or the location conflict. The voter identifiers are the voter's full name, address, or voter ID number as well as combinations thereof that were provided with the voter check-in document. The discrepancy resolution signal is inherently associated with a voter check-in document due to the initiation of the ballot release process.

The resolution process attempts to resolve any discrepancies that may prevent an eligible voter from receiving a ballot. Common situation that can be resolved by the voter service kiosk 814 through the operations of the resolution engine 824 are: The voter is eligible to vote and has not voted, but is at the wrong polling location; The voter is eligible to vote, has not voted, and is at the correct polling location, but an erroneous check-in results in an ineligible to vote status through the voter roll 820; and The voter is eligible to vote, has note voted, and is at the correct polling location, but has recently changed residence.

The embodiment in a voter service kiosk 814, distinct and separate from digital pollbook 802, of the resolution engine 824, enables the practical improvement of voter line processing, where exceptions are handled elsewhere than at the head of the line with a pollbook and poll worker. However, the resolution engine 824 could alternatively be embodied in a digital pollbook 802, and its up to the voter or poll worker whether to resolve at the head of the line, or separately at a voter service kiosk 814 if one is in use.

The resolution engine 824 resolves the scenario where voter is eligible to vote and has not voted, but is at the wrong polling location, by using the voter identifiers to validate the voters correct information through a voter registration management system database 828 and using the discrepancy parameters to retrieve resolution instructions from a jurisdictional solutions database 826. The voter registration management system database 828 is a centralized database utilized by the voter service kiosk 814 to correctly locate the voter's registration details from when they registered to vote. The jurisdictional solutions database 826 is a database containing voting rules and regulations for the particular jurisdiction that the polling location is found in and possible protocols or solutions for handling exceptional situations preventing a voter from getting a ballot. In the aforementioned scenario the resolution engine 824 would use the voter identifiers to validate that the voter is eligible to vote but is at the wrong location based on the information from the voter registration management system database 828, and would use the discrepancy parameters to query the jurisdictional solutions database 826 for resolution instructions. In this case the resolution instructions would control the resolution engine 824 to generate external instructions 836 informing the voter of the closest polling location that they would be eligible to vote in.

The resolution engine 824 resolves the scenario where an erroneous check-in results in an ineligible to vote status through the voter roll 820 by using the voter identifiers to validate that the voter's registration information in the voter registration management system database 828 and if the voter affirms that they have not voted, the discrepancy parameters would be used to query the jurisdictional solutions database 826 for resolution instructions. In the aforementioned scenario, depending on the jurisdiction in which the polling location is found, the jurisdictional solutions database 826 would return resolution instructions that generate a resolved check-in document 812 allowing the voter a special exception to receive a ballot after signing an affidavit. The resolved check-in document 812 would be transmitted to the digital pollbook interface 806 and transformed into a ballot access exception. The ballot access exception is a signal that circumvents the process of querying the voter roll 820 and communicates with the ballot release gateway 810. The ballot access exception comprises the voter identifiers and annotation instructions to record the exception to the voter entry in the voter roll 820 and the digital pollbook manager database 830.

The resolution engine 824 resolves the scenario where has recently changed residence and does not appear in the in the voter roll 820 by using the voter identifiers to validate that the voter is eligible to vote and has an affidavit affirming that they have recently changed residence in the voter registration management system database 828, and would use the discrepancy parameters to query the jurisdictional solutions database 826 for resolution instructions. The jurisdictional solutions database 826 would return resolution instructions that generate a resolved check-in document 812 allowing the voter a special exception to receive a ballot. The resolved check-in document 812 would be transmitted to the digital pollbook interface 806 and transformed into a ballot access exception. The annotation instructions would record the exception to the voter entry in the voter roll 820 and the digital pollbook manager database 830.

In some embodiments, a method for controlling ballot access may include transforming a voter check-in document into a ballot request signal for transmission to a voter roll through operations of a digital pollbook, querying the voter roll for a voter entry associated with the voter check-in document as controlled by the ballot request signal, transmitting a discrepancy resolution signal to a voter services kiosk through operations of the digital pollbook, generating an eligibility signal for a ballot release gateway upon closure of a check-in status switch of the voter entry through operations of the digital pollbook, and/or releasing a blank ballot through the ballot release gateway and transmitting a voting status closure signal for the voter entry as controlled by the eligibility signal.

In some embodiments, the voter check-in document is a physical document may include voter identifiers in the form of a voter's full name, address, or voter ID number as well as combinations thereof, where a poll worker manually inputs the voter identifiers through the digital pollbook interface.

In some embodiments, the voter check-in document is a digital check-in document may include voter identifiers in the form of a voter's full name, address, or voter ID number as well as combinations thereof, in a machine readable format that is transmitted to a digital pollbook interface through operations of a scanner.

In some embodiments, the voter check-in document is a resolved check-in document generated through a resolution engine of the voter services kiosk may include voter identifiers in the form of a voter's full name, address, or voter ID number as well as combinations thereof, and a ballot access exception to release a ballot and annotate the exception.

In some embodiments, transmitting the discrepancy resolution signal to the voter services kiosk may include detecting the voter entry associated with the voter check-in document, identifying a closed state for either the check-in status switch or the voting status switch of the voter entry as a status conflict through operations of the digital pollbook, and/or transforming the status conflict into the discrepancy resolution signal and transferring the discrepancy resolution signal to the voter services kiosk.

In some embodiments, the detecting the voter entry associated with the voter check-in document may include the check-in status switch and a voting status switch in the voter roll.

In some embodiments, transmitting the discrepancy resolution signal to the voter services kiosk may include determining the absence of the voter entry associated with the voter check-in document in the voter roll as a location conflict and/or transforming the location conflict into the discrepancy resolution signal and transferring the discrepancy resolution signal to the voter services kiosk.

In some embodiments, transmitting the discrepancy resolution signal to the voter services kiosk may include transforming the discrepancy resolution signal into voter identifiers and discrepancy parameters through operations of a resolution engine, retrieving resolution instructions from a jurisdictional solutions database for the discrepancy parameters through operations of the resolution engine, validating the voter identifiers through a voter registration management system database through operations of the resolution engine, and/or generating a resolved check-in document for the discrepancy resolution signal in the resolution engine as controlled by the resolution instructions.

In some embodiments, transmitting the discrepancy resolution signal to the voter services kiosk may include generating external instructions for the discrepancy resolution signal in the resolution engine as controlled by the resolution instructions.

In some embodiments, generating the eligibility signal for the ballot release gateway may include detecting the voter entry associated with the voter check-in document with an open state check-in status switch in the voter roll and/or transforming the open state of the check-in status switch into a closed state as controlled by the ballot request signal.

In some embodiments, releasing the blank ballot through the ballot release gateway may include receiving the eligibility signal for the voter entry associated with the voter check-in document in the ballot release gateway; transforming the eligibility signal into the voting status closure signal and ballot release instructions; transmitting the voting status closure signal to a digital pollbook manager database and the voter roll as controlled the ballot release instructions; and/or transforming the open state of a voting status switch, for the voter entry, into a closed state as controlled by the voting status closure signal.

In some embodiments, the digital pollbook manager database may include a group of digital pollbooks communicably coupled to one another through the digital pollbook manager database.

In the case of a fully active voter with no flags on record, the user in a management system 104 session may request the management system 104 to prepare an on-boarding document (OBD), which is a document that includes: (1) information that will be useful on election day, for example, polling place location and maps; (2) information to be used by a poll worker during check-in, for example, readily identifiable voter name address and status, to save the time and avoid potential confusion for verbal conveyance of this information during the check-in process;

(3) information intended for automated consumption by a digital pollbook (DPB) or other form of electronic pollbook, including but not limited to the voter's voter ID number, name, and address encoded in a machine readable form including but not limited to the bar-code, the QR-code, or a font convenient for optical character recognition. The term “pre-check process” is used below to describe the activity in which a voter determines that they are eligible to vote in person, and optionally obtains an OBD to facilitate the in-person check-in process.

In the case of in-person voting, the access to a ballot (paper or digital) is generally gated by eligibility; where eligibility may be a combination of being present on a voter roll for a given location, and not having previously voted in the same election. Hence, the voter roll serves both as a roster and a means of recording a previous check-in in order to gate a second check-in.

An in-person voter check-in process is a domain-specific instance of the general process, in which several users access the same service or item at the same location; each prospective user stands in one of one or more lines to get to the head of a line where eligibility for access is checked before an access is granted.

The present disclosure describes a number of hardware and software enabled processes for streamlining the voter check-in process, with a number of variations on the processes and how they use computing technology in a variety of ways that are consistent with existing U.S. election administration practice.

In some embodiments, in a voter check-in process, a voter's stated identity is matched to a record in a pollbook. If there is a match, and the pollbook does not indicate that the voter has already voted, the match is recorded in the pollbook, and the voter completes the check-in process and gains access to a ballot. If the same voter attempts to check in again using that pollbook, and the previous check-in has been recorded, the voter is not allowed to vote again. If there is no match, several jurisdiction specific options may be chosen, including a provisional voting or a same-day registration.

In some embodiments, a check-in action uses a digital pollbook (DPB) implemented as a local software application on a computing device such as a tablet computer or laptop. In some embodiments, the DPB may be of other manifestations, such as a centrally managed client/server software system with a web client, a mobile client, or a native client application on a conventional personal computer. A DPB includes the basic functions of a paper pollbook: checking whether a person is on the voter roll and is not recorded as having voted already; and recording that the voter has now checked in.

In some embodiments, a voter services kiosk (VSK) handles situations where a person at the head of the line is not able to immediately check in and vote. Rather than handling the exception at the head of the line, which increases wait time, the person is directed to a VSK to get assistance in handling their exception and, if possible, gaining access to vote. The VSK may be implemented as a standalone kiosk-style combination of computer hardware and software, but may be of other manifestations, such as a tablet-based or laptop-based system, a centrally managed client/server software system with a web client, a mobile client, or a native client application on a conventional personal computer.

When a person at the head of a check-in line is a voter who has not completed the precheck process, there are several possible outcomes.

In some embodiments, the voter may have active status with no flags and is in a voting place for which the voter is eligible, and the pollbook may indicate that the voter has not yet voted. In such case, the check-in process may be completed quickly, regardless of the specific pollbook method chosen, such as by swiping a magnetic coded ID card containing voter ID data; scanning a bar-coded paper Voter Registration Card containing voter ID data; scanning a digital image of such a bar code from a mobile device; proximity scanning of a radio frequency identification (RFID), an infrared, a Bluetooth, or a similarly enabled device containing voter ID; entering voter data of full name and address; entering partial voter data for search of voter rolls, and picking the correct entry from search results; entering partial voter data with short-list search autocomplete, and picking the correct entry from search results; or using any common user interface technologies for picking a pollbook entry using name and address, voter ID number, or other formulation of voter roll entry, from a large list of pollbook entries. Of course, paper pollbook check-in may be additionally (or alternatively) available.

In some situations, the voter may have an active status but is in a polling place for which the voter is ineligible, for example, an election day polling place for a precinct other than the voter's precinct, or an early voting center that serves several but not all precincts, and does not serve the voter's precinct.

In some situations, the voter may have an active status and is properly located, but the DPB indicates that the voter has already voted, perhaps because of an erroneous check-in of a previous voter (e.g., a voter picking a voter roll entry from an alphabetical pick list, accidentally picking the voter roll entry adjacent to the correct one, especially if the adjacent record is visually very similar). In cases like these, when the second family member arrives after the first family member checked in erroneously, the second family member is not eligible to check-in immediately. In many U.S. jurisdictions, the second voter may vote provisionally and use an affidavit to explain the double check-in situation (or other erroneous check-in situation).

In some situations, the voter may be correctly located without a previous check-in, but has a status issue such as those described above. In some situations, the voter may simply not be on the voter rolls because sometimes people may show up with the misimpression that they are registered. In other situations, the voter rolls may be prepared inaccurately, omitting people who have registered to vote.

In these situations, the check-in process may include:
(a) the check-in attempt shows that the voter cannot immediately proceed to vote;
(b) the DPB or the poll worker operating the DPB communicates the problem to the voter, and offers three basic choices for resolution:
(1) proceed to a VSK for further assistance;
(2) attempt to resolve the issue with the poll worker's assistance while remaining at the head of the check-in line; or
(3) attempt to resolve the issue away from the head of the line, but with a poll worker “trouble-shooter” alone, rather than with the VSK or with the VSK and the assistance from a trouble-shooter;
(c) once the resolution has been completed, if the voter is eligible to vote, for example, provisionally, the voter may re-enter the head of the line, present the materials created during resolution, and proceed to vote; or
(d) once the resolution has been completed, if the voter is not eligible to vote, for example, if the voter is at the wrong polling place, the voter is clearly informed of the options, for example, going to a correct polling place, or going to an all-precinct voting station at county election headquarters.

When the person at the head of a check-in line is a voter who has completed the precheck process, there are several possible outcomes.

The voter may have active status with no flags, is in a voting place for which she is eligible, and the pollbook indicates that she has not yet voted. In such case, the check-in process should complete quickly, regardless of the specific pollbook method chosen, such as by a DPB scan of a paper or a digital OBD.

In some situations, the pre-check process may have identified an issue, and may have prepared the voter to address the issue at the head of the line. When a voter checks in by scanning the DPB, the DPB can clearly communicate to both the voter and the poll worker what the situation is, and what the pre-prepared resolution is. The resolution can then be performed expeditiously. The range of issues that can be identified may be jurisdiction specific, and the resolutions to the issues may be issue specific; however, a common situation is one in which a first time voter must show one of a list of acceptable forms of id; another common situation is provisional voting at a polling place of a new residence, coupled with an affidavit that the voter recently moved from the old address on file in the voting associator 206 to a new address.

In some situations, an absentee voter who did not receive a ballot in time to mail it back will be noted by the DPB as an absentee voter, but the voter has already prepared the paperwork to surrender the absentee ballot (perhaps as part of an on-boarding process), and has taken the ballot along to the voting location. In such case, the absentee voter may surrender the absentee ballot, and proceed to vote in person. The term “noted by the DPB” indicates that the person has an OBD, presents it to the DPB, and the DPB explains the situation and the corresponding expected action to the poll worker. Where a DPB is not available, a poll worker may refer to the OBD and determine how to proceed.

In some embodiments, an absentee voter who prefers to drop off the ballot in person rather than by mail will be noted by the DPB as such, and the completed absentee ballot can be presented for drop-off into a ballot box.

In some embodiments, a voter who must vote provisionally for any of several reasons will be noted by the DPB as a provisional voter who can provide the already-completed affidavit, and proceed to vote provisionally.

In some embodiments, an unregistered voter planning to make use of the same-day registration will be noted by the DPB as such, and can present the already prepared paperwork, and proceed to vote.

In some embodiments, a voter who, despite the pre-check process, is mis-located, will be noted by the DPB as such, and the poll worker can direct the voter to any of the optional voting places listed on the on-boarding document.

Most issues and resolutions can be expedited in a similar manner, but a few issues, for example, the double check-in issue described above and the case where a provisional ballot affidavit is needed, may require the use of the VSK or other alternatives.

When DPBs are used, different check-in processes may be employed to handle different situations.

In some situations, the voting place is not networked, and the DPB may be in alphabetical mode (e.g., there is one DPB allocated to a particular segment of the alphabet). Each voter may go to the line at the head of which is the DPB for the letter of the voter's last name. When each voter can only vote at one location, double voting may be prevented. In some embodiments, there are other ways to uniquely segment voters, such as alphabetical sorting of the first name, last name, street name, street type, data of birth ranges or year or birth ranges.

In some situations, the voting system is not networked, and the DPB may not be in alphabetical mode (e.g., each DPB can check in any voter). In such embodiments, the DPB may not prevent double check-in. For example, Voter XYZ may check in at line A, vote, and then come back to line B, check in and vote again. In such a case, DPBs may be used to detect multiple-voting, by consolidating the data from the DPBs and identifying whether multiple voting instances were documented for the same voter.

In some situations, the voting system is connected to a local area network, and the DPB can be in A-Z/A-Z (non-alphabetical) mode. In an individual voting place, DPBs are locally networked. Anyone can check in any line. Each DPB communicates check-in status with other DPBs. Alternatively, a “master” system may distribute to each DPB for the update of every transaction, or each DPB may check with the “master” system for the update. In such a way, double voting may be prevented locally, but double voting in situations where a voter may vote at multiple places may still exist.

In some situations, the voting system is connected to a wide area network, and the DPB can be in A-Z/A-Z mode. In these situations, each DPB may communicate with other DPBs in other voting locations directly, through a local “master” system that communicates to each DPB in a voting location, or through a local “master” system that communicates to a “central master.” This arrangement may prevent double voting within one jurisdiction.

In some situations, the voting system is connected to a geographically wide network, and the DPB can be across jurisdictions to prevent double voting in different jurisdictions.

In some situations, the DPB can also be in A-M/N-Z (e.g., alphabetical) mode combined with various networking and master schemes.

In some situations, the system includes a scanner 832 to scan a bar-code from a voter-ID card. In these cases, the on-boarding document would include the same conventional bar-code, and the check-in process will be similar for unflagged and correctly located voters who have not checked in.

In some situations where there is an issue, the pollbook scan may not be able to capture the additional information on the on-boarding document that details the voter status, situation, and pre-prepared remedies. In such case, the on-boarding document itself may be used by the voter to convey to the poll worker the details of the voter's case, and what remedies the voter is already prepared for. Alternatively, the on-boarding document may be used as a visual aid or a verbal aid to voter discussion with the poll worker.

For voters who did not pre-check in, the use case is similar to the use case discussed above for voters who did not pre-check.

In some situations, a paper pollbook is used instead of a DPB.

In case where the voter is on the voter rolls, not flagged and in the correct location, and has not checked in before, the on-boarding document is not used even if the voter has one.

For other cases, the on-boarding document, if present, can be used for the same explanatory purposes described above to expedite the resolution process.

In cases where the resolution was not pre-prepared, the VSK option can also be used to reduce waiting time in the line behind the voter.

All of the above embodiments may have an additional variant in which the polling place lacks a VSK.

In the case where a paper pollbook is used, the on-boarding document, if present, may be used for explanatory purposes.

In the case where an e-Pollbook is used, the on-boarding document usage is the same as described above. If the e-Pollbook is not present, or is present but not sufficient (e.g., allowing multiple check-in), and the VSK option is not available, issues may be handled manually at the head of the line or in a separate manual trouble-shooting station.

Each of these variations also applies in different types of voting place operation, such as an election day precinct polling place, an election day voting center, an election day HQ as an all-precinct voting center, an early vote center, and a HQ as an all-precinct vote center.

In block 902, routine 900 transforms a voter check-in document into a ballot request signal for transmission to a voter roll through operations of a digital pollbook.

In block 904, routine 900 queries the voter roll for a voter entry associated with the voter check-in document as controlled by the ballot request signal.

In block 906, routine 900 transmits a discrepancy resolution signal to a voter services kiosk through operations of the digital pollbook.

In block 908, routine 900 generates an eligibility signal for a ballot release gateway upon closure of an open check-in status of the voter entry through operations of the digital pollbook.

In block 910, routine 900 releases a blank ballot through the ballot release gateway and transmitting a voting status closure signal for the voter entry as controlled by the eligibility signal.

In done block 912, routine 900 ends.

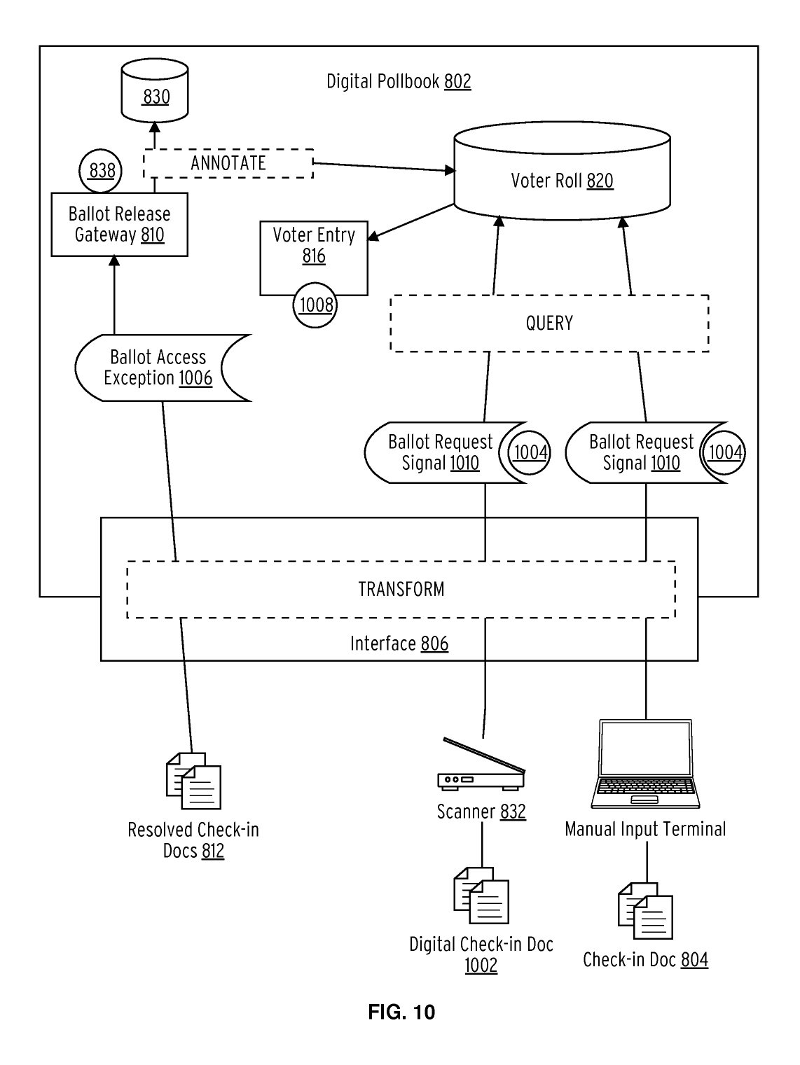

Referencing FIG. 10, the system for controlling ballot access receives voter check-in documents comprising physical voter check-in document 804, Digital check-in document 1006, and resolved check-in document 812 through the digital pollbook interface 806. The digital pollbook interface 806 receives the Digital check-in document 1006 from a scanner 832. The digital pollbook interface 806 receives manual inputs for the physical voter check-in document 804. The digital pollbook interface 806 transforms the information in the Digital check-in document 1006 and the physical voter check-in document 804 into ballot request signal 1004 comprising voter identifiers 1002 used to query the voter roll 820 for the voter entry 816 with voter identifiers 1010 matching the voter identifiers 1002.

The resolved check-in document 812 is transformed by digital pollbook interface 806 into a ballot access exception 1008 which bypasses the voter roll 820 and communicates with the ballot release gateway 810 to release the blank ballot 838 and annotate the release in the digital pollbook manager database 830 and voter roll 820.

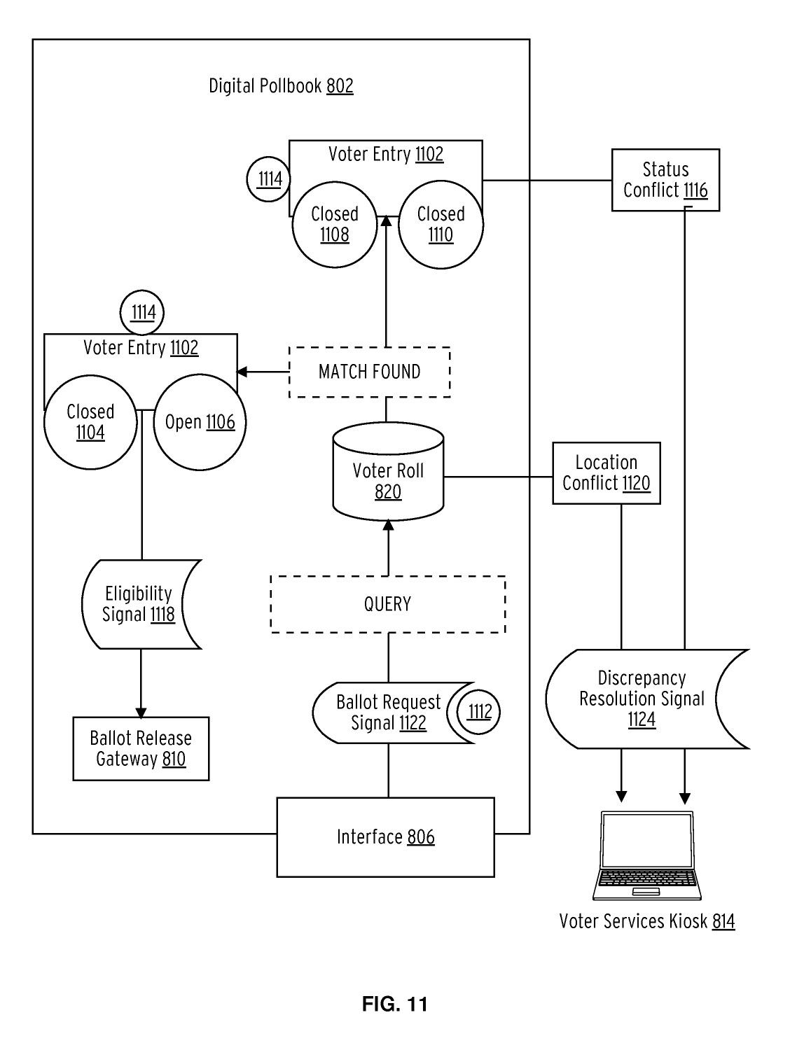

Referencing FIG. 11, the system for managing ballot access is operable under three distinct conditions to query the voter roll 820 with a ballot request signal 1122: voter entry 1102 is found and check-in status switch 818 and voting status switch 822 are, initially, in an open state; voter entry 1102 is found but check-in status switch 1108 and voting status switch 1110 are in a closed state; and detecting no voter entry matching the voter identifiers 1112 of the ballot request signal 1122.

For the situation where check-in status switch 818 and voting status switch 822 are initially in an open state, the ballot request signal 1122 closes check-in status switch 818 generating an eligibility signal 1118 received by ballot release gateway 810 in response.

For the situation where check-in status switch 1108 and voting status switch 1110 are found in a closed state, digital pollbook 802 identifies the closed states as a status conflict 1116 that is transformed into a 1124 and transferred to the voter service kiosk 814.

For the situation where the no voter entry matching the voter identifiers 1112 is found in the voter roll 820, the outcome is identified as a location conflict 1120 due to the location specific nature of the voter roll 820 and a location conflict 1120 is transformed into a 1124 and transferred to the voter service kiosk 814.

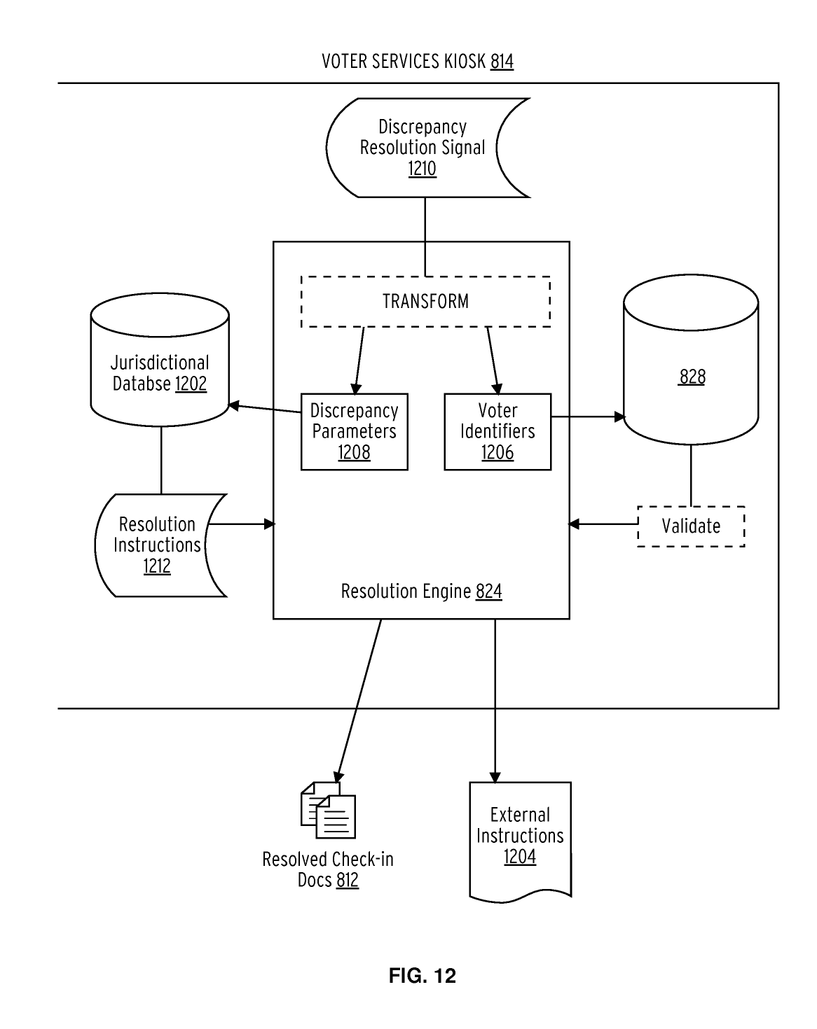

Referencing FIG. 12, the voter service kiosk 814 resolves discrepancies for a voter through the user of a resolution engine 824. The resolution engine 824 transforms the discrepancy resolution signal 1202 into a discrepancy parameters 1210 and voter identifiers 1208. The resolution engine 824 retrieves resolution instructions 1212 from the Jurisdictional solutions database 1204 for the discrepancy parameters 1210. The resolution engine 824 validates the voter identifiers 1208 through the voter registration management system database 828. The resolution engine 824 generates a resolved check-in document 812 for the discrepancy resolution signal 1202 as controlled by the resolution instructions 1212. Alternatively if the resolution instructions 1212 dictates a resolution not involving the digital pollbook, the resolution engine 824 generates an external instructions 1206 as controlled by the resolution instructions 1212.

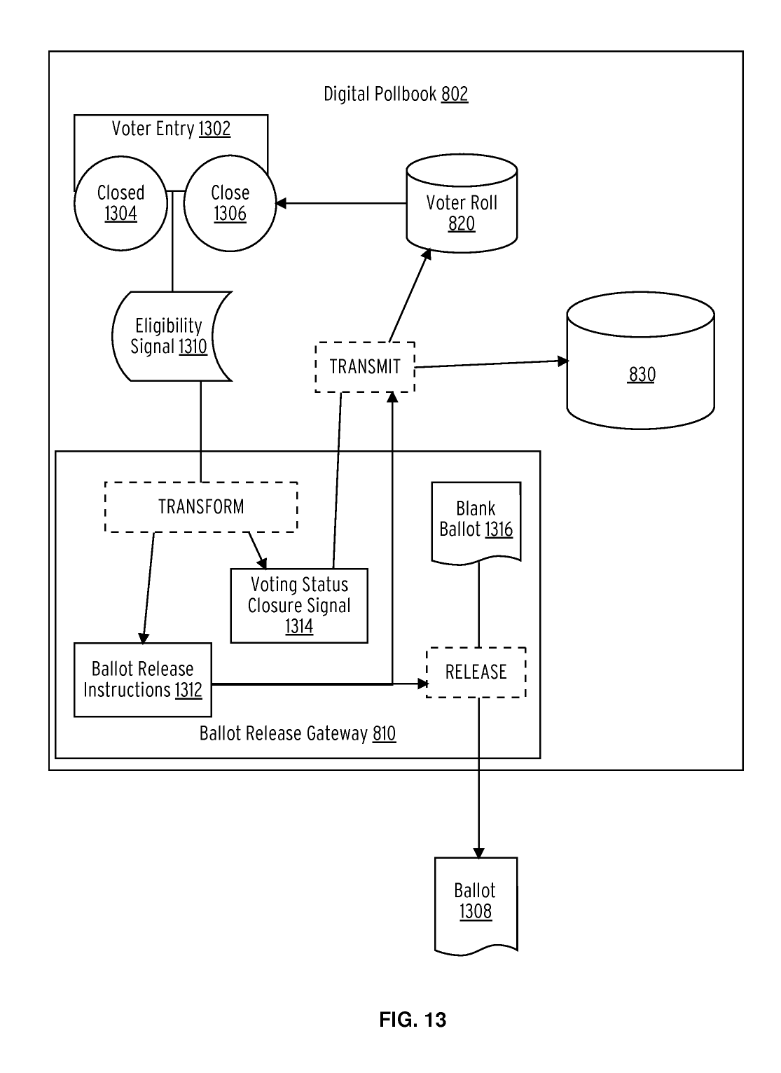

Referencing FIG. 13, the ballot release gateway 810 receives an eligibility signal 1310 from a voter entry 1302. The 610 transforms the eligibility signal 1310 into ballot release instructions 1312 and voting status closure signal 1314. Voting status closure signal 1314 is transmitted to the voter roll 820 and the digital pollbook manager database 830 to change the state of voting status switch 1306 from an open state to a closed state. The transmission of the voting status closure signal 1314 is controlled by the ballot release instructions 1312. The ballot release instructions 1312 control the release of the retained blank ballot 1316 through the ballot release gateway 810 into the ballot 1308 outside the digital pollbook 802. It should be noted that the ballot release instructions 1312 is an extension of the eligibility signal 1310 and control of transmission and release is dependent on the eligibility signal 1310.

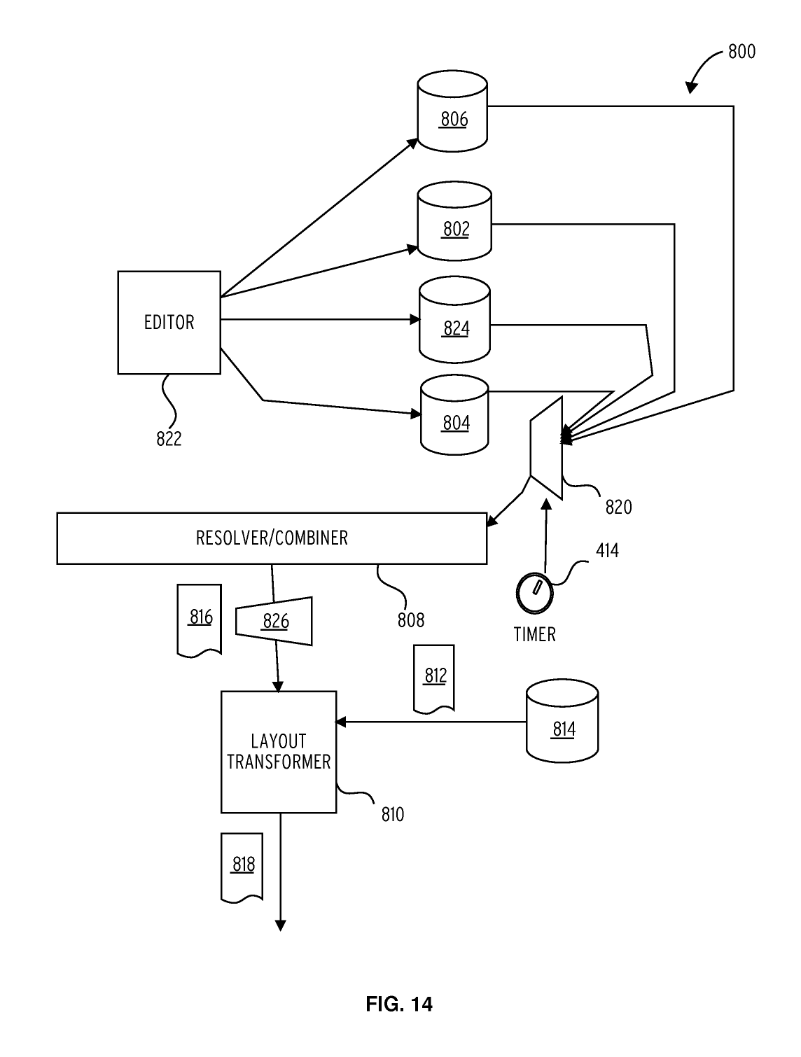

FIG. 14 illustrates an embodiment of a ballot generation system 1400. The ballot generation system 1400 operates by applying the outputs of various associators to a gate 1420 controlled by the timer 414 and operating an attribute combiner and resolver (election definer) 1408 to transform these inputs into optical contrast transform controls 1416. The optical contrast transform controls 1416 are applied via a gate 1426 to a layout transformation logic 1410, which transforms the optical contrast transform controls 1416 according to an optical contrast layout template 1412 read from an optical contrast layout associator 1414, resulting in a ballot 1418.

The various settings to the attribute combiner and resolver (election definer) 1408 are state election attributes from a state attribute associator 1406, particular election attributes from an event attribute associator 1402, election candidate attributes from a candidate attribute associator 1424, and jurisdictional attributes from a jurisdiction attribute associator 1404. The settings in the various associators may be changed by operation of election configuration logic 1422, however the gate 1420 ensures that changes cannot be applied after a configured deadline before an election.

The attribute combiner and resolver (election definer) 1408 combines the settings from the various associators and resolves conflicts (e.g., settings from higher jurisdictions may preempt settings from more local jurisdictions).

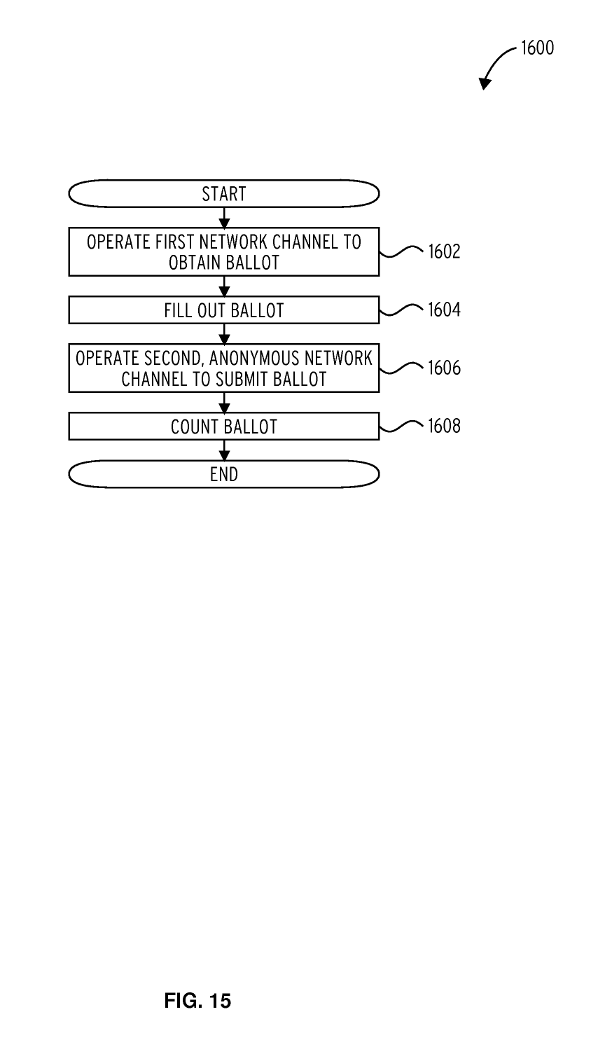

FIG. 15 illustrates an embodiment of an election execution process 1500. A first network channel is operated to obtain a ballot (e.g., see FIG. 14) at block 1502. The voter fills out the ballot at block 1504. A second, anonymous network channel is operated to submit the filled out ballot at block 1506. The ballot is counted at block 1508.

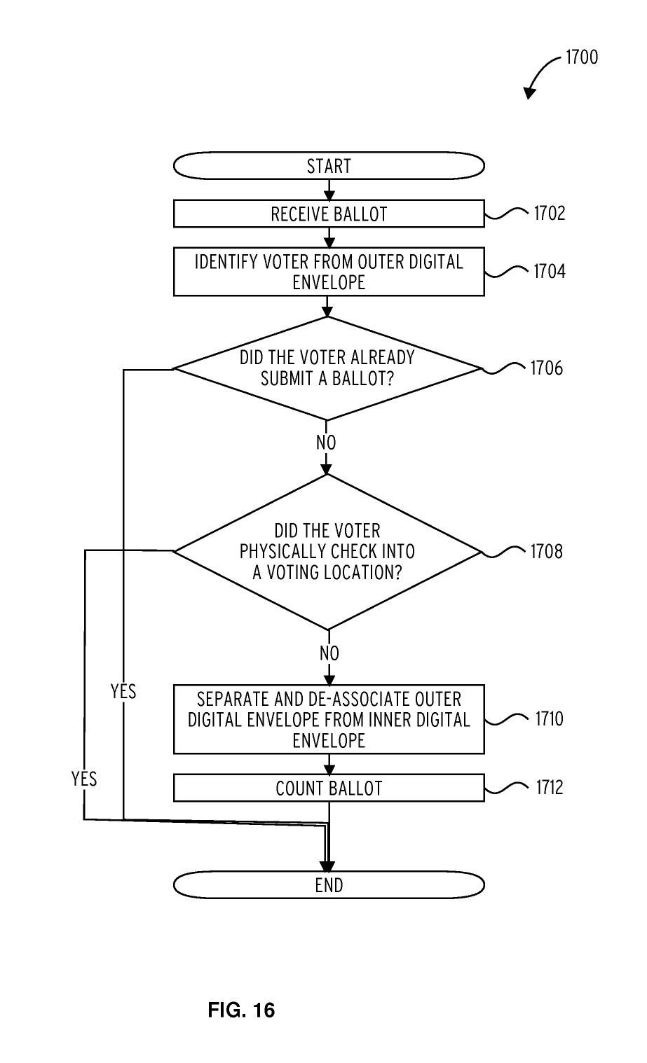

FIG. 16 illustrates an embodiment of a ballot adjudication process 1600. An electronic ballot is received at block 1602. An identify of the voter submitting the ballot is identified from an outer digital envelope at block 1604. At decision block 1606 a check is made if the voter already submitted a ballot. If yes, the process concludes (the ballot is not counted). If no, at decision block 1608 a check is made if the voter physically checked into a voting location (perhaps to accidentally vote again). If yes, the process concludes, otherwise, the inner digital envelope comprising the digital ballot is separated and de-associated from the outer digital envelope comprising the voter identification at block 1610. The (now anonymous) ballot is counted at block 1612.

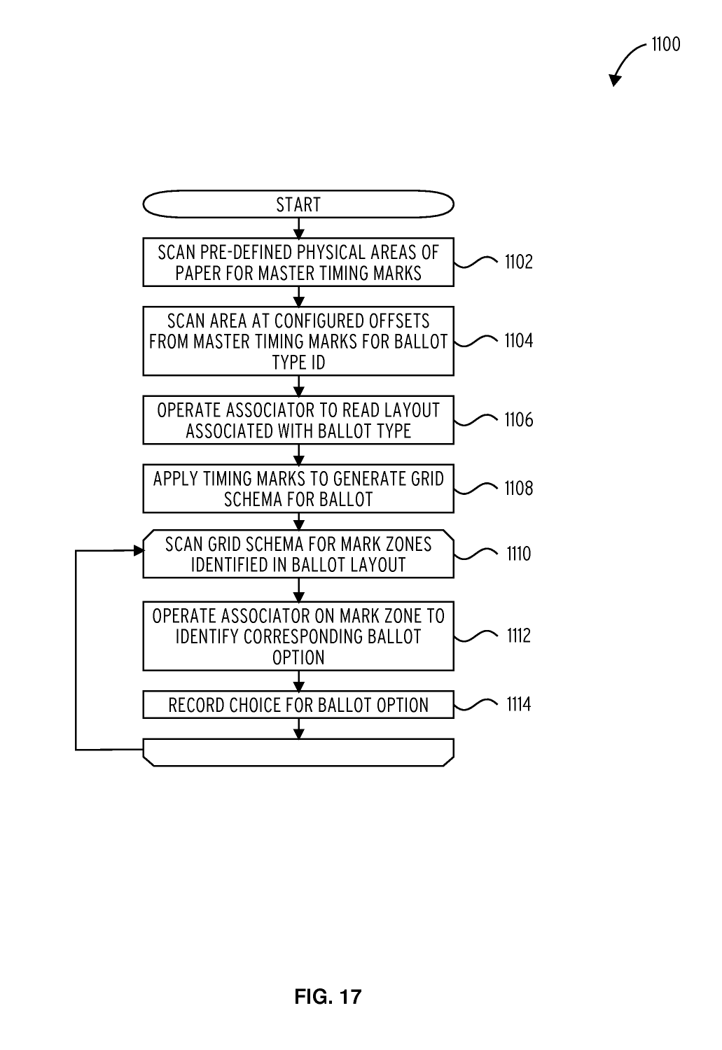

FIG. 17 illustrates an embodiment of a ballot counting process 1700. This process is carried out for paper ballots.

At block 1702 an optical scan is performed on the paper ballot to identify master timing marks in pre-defined (on the ballot and to the ballot reading machine) areas. At block 1704 the machine scans an area at configured offsets from the master timing marks to locate and read a ballot type identifier. At block 1706 the ballot reading machine operates an associator to read and configure itself with a layout associated with a ballot type. At block 1708 the timing marks on the ballot are read and applied to generate a grid schema (grid line coordinates) for the ballot. At opening loop block 1710 the machine then enters a loop scanning the grid schema for mark zones identified in the ballot layout. At block 1712 an associator is operated on the mark zone to identify corresponding ballot options for the mark zone (e.g., what vote selection the mark zone corresponds to). At block 1714 the machine identifies if the ballot option is marked or not, or if a choice is written in, and records the choice made for that ballot option.

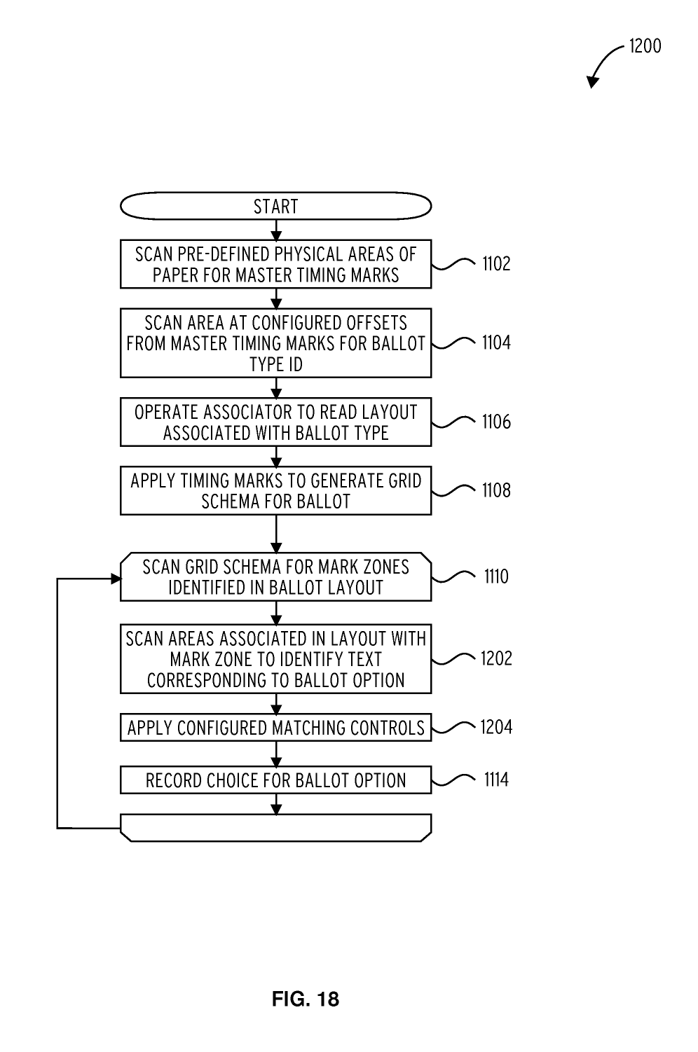

FIG. 18 illustrates an embodiment of a ballot counting process 1800. The process has many acts in common with the ballot counting process 1700, with some differences.

At block 1802 areas in the layout associated with a mark zone (usually adjacent to it in either the X or Y plane of the ballot paper) identified in the layout are scanned to identify text corresponding to the mark zone ballot option. This is useful where the ballot layout definition does not identify an election choice associated with the mark zone, but the adjacent text is description of the option.

At block 1804 matching controls are applied to set a threshold or rules for positive identification of text or codes associated with the mark zone.

The following section presents a number of methods for machine counting of alternative opscan ballots, and a machine ballot counter that supports not only pre-provisioned grid-based mark scanning but also other methods of scanning. Thus, a single ballot counting device can count a large set of disparate ballots in a way that does not disadvantage any class of voters, and provide a uniform mechanism of recording ballot data and count data. Several classes of ballot format that can be counted by such a multi-format ballot counter are described below.

Ballot A is a pre-printed hand-mark ballot with timing marks, ballot style identifier, and mark zones for each ballot option (candidate or ballot question response) for each ballot item (contest or referendum), for which the interpretation depends on the counting device having an election definition and mappings from each ballot option to a mark zone and from each mark zone to a ballot option (or noted as unused).

Ballot A can also be a similar ballot created by a ballot marking device by inking a pre-printed ballot; or a similar ballot created by a ballot marking device by printing the ballot on blank paper.

Ballot B is a pre-printed hand-mark ballot with timing marks, ballot style identifier, and mark zones for each ballot option, for which the interpretation does not rely on the relationship between the mark zones and the ballot options. The interpretation uses optical character recognition (OCR) of text near a mark zone in order to identify the ballot option chosen by the voter and represented by a mark in the mark zone. The results of the OCR are compared to the text in an election definition.

Ballot B can also be a similar ballot created by a ballot marking device by inking a pre-printed ballot; or a similar ballot created by a ballot marking device by printing the ballot on blank paper.

Ballot C is a machine-marked ballot with timing marks and ballot style identifier, listing the ballot items and ballot options chosen by the voter, for which the interpretation is based on the OCR of the text near timing marks, while omitting non-chosen ballot choices. Alternatively, Ballot C can be a similar ballot with one or more of the following properties: (1) affirmative indication of voter non-choices, i.e., ballot items in which the voter did not choose a ballot option, or did not choose the maximum number of ballot options; (2) no timing marks for individual ballot items or options, but a mark-location scheme based on grid implied by master timing marks in page corners, and a spacing parameter either assumed or specified in machine-readable form on the printed ballot; (3) no timing marks at all, but a mark-location scheme based on grid implied by page corners rather than by master timing marks; and (4) no timing marks, where a digital image processing techniques for finding text.

Ballot D is machine-mark ballot like Ballot C, but is produced not by software printing text based on voter selections, but by software rendering text typed by the voter. Alternatively, Ballot D can be a similar ballot with one or more of the properties listed in Ballot C above. This type of ballot is fundamentally like a FWAB being filled out using a typewriter to fill in contest name and candidate name, or referendum name and ballot questions response, with (a) varying degrees of assistance (timing marks etc.) for interpretation pre-printed on the blank FWAB form, or (b) varying types of assistance from the software that receives the voter's typed input and prepares the ballot document.

Ballot E is a hand-mark ballot like Ballot D, with handwritten text indicating contest/candidate or referendum/response printed in the proper areas on a form.

Ballot F is a hand-mark ballot like Ballot E, but is prepared on completely blank paper with no guidance for format or spacing.

Ballot G is a machine-generated ballot like Ballot F, but is created using a computer, a word processor, and a printer, rather than by handwriting.

Ballot H is a ballot similar to Ballot C to Ballot G, but contains one ballot item and ballot option(s) for the one ballot item. Although such a ballot does not match U.S. election practice, it matches practices in European countries where each election has one or a few contests, each with a distinct ballot box at each voting location, and voters deposit into the box ballots indicating their choice of candidate for the contest. This practice is an echo of even older practices of placing colored stones or tokens into an opaque “ballot pot” with each color representing a single candidate.

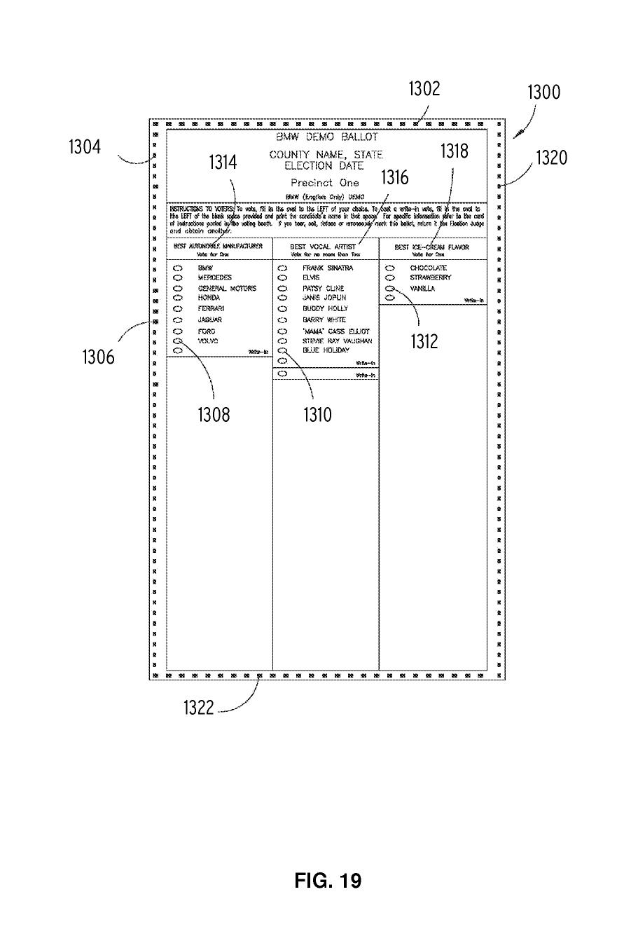

FIG. 19 illustrates an example of a paper ballot 1900. The paper ballot 1900 comprising timing marks (top edge timing marks 1902, left edge timing marks 1904, right edge timing marks 1920, master timing marks 1906, and bottom edge timing marks 1922) to aid an optical scanning machine with alignment of the ballot (e.g., de-skewing) and with formation of a grid schema for the ballot by which intersection points on the grid schema may correspond to configured areas in the ballot layout, such as heading 1914, heading 1916, heading 1918, mark zone 1908, mark zone 1910, and mark zone 1912.

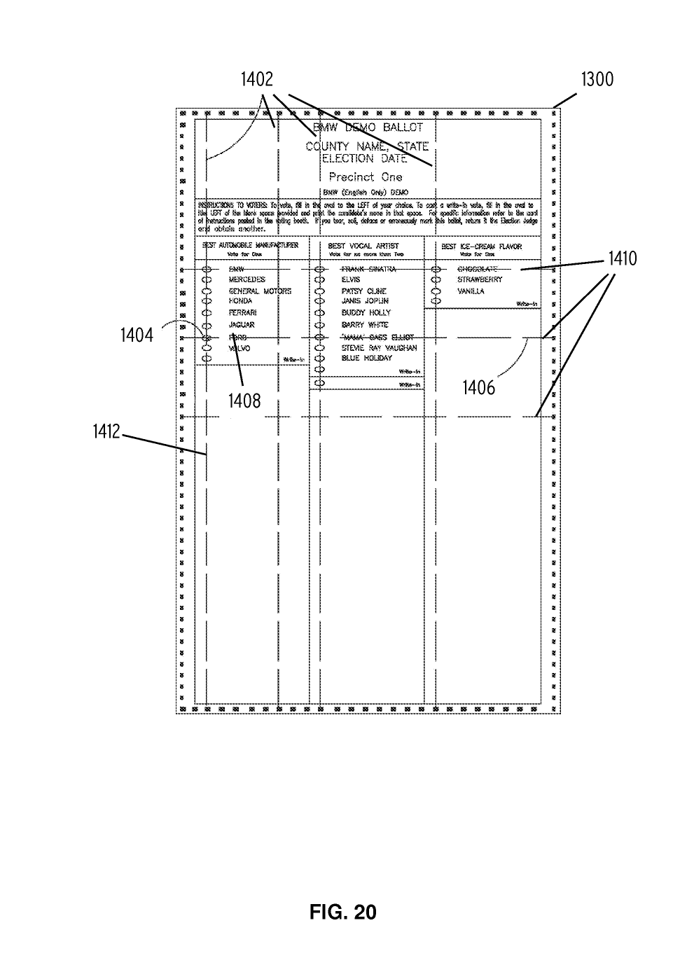

FIG. 20 illustrates a grid schema for a paper ballot 1900. The top edge timing marks 1902 and bottom edge timing marks 1922 are applied to generate vertical grid lines 2002 and horizontal grid lines 2010. For example, center points for corresponding ones of the top edge timing marks 1902 and bottom edge timing marks 1922 may be aligned and interpolated to form vertical grid line 2012. Likewise, center points of corresponding ones of left edge timing marks 1904 and right edge timing marks 1920 may be aligned and interpolated to form horizontal grid line 2006.

The ballot layout may associate intersection points of horizontal and vertical grid lines with mark zones, associated text, headers, and other meaningful content or areas of the ballot. For example, mark zone 2004 may be associated with selection (or non selection) of a vote for “Ford” as the best auto manufacturer. If the ballot layout does not associate this area with “Ford”, the option may still be associated by the ballot reading machine, if the layout associates a mark zone associated option 2008 (readable with OCR, for example) with the mark zone 2004.

For several of the counting methods described herein, the counting system determines whether the dark pixels in a fixed set of pixels comprising a mark zone constitute a valid mark. Current practice includes a number of different schemes, partly due to differences in the proprietary systems, and partly due to the need to meet a variety of different state-specific requirements on what constitutes a valid mark. For example, different states have different thresholds for a “full” mark zone, and different interpretations of marking methods, such as circling a mark zone, striking through, or marking with an X.

In a multi-format ballot counter, a different set of mark analysis rules may be needed for the analysis of different ballot formats. Such analysis rules can be a part of the configuration of the counting device. The configuration may be controlled by election officials, such that they can decide in a manner appropriate for their local jurisdiction which types of mark rules apply for each distinct format.

In some embodiments, even within a single ballot format, it is possible to combine multiple analysis methods into an arbitrary decision tree. Such a decision tree can be a part of the configuration of a ballot counting device, again, under the election official's control rather than being “baked into” the counting device. Some decision tree elements can be parameterized by, for example, the percentage of pixels filled, such as recording a mark if >70% of the mark zone is dark and there are no dark pixels adjacent to the mark zone.

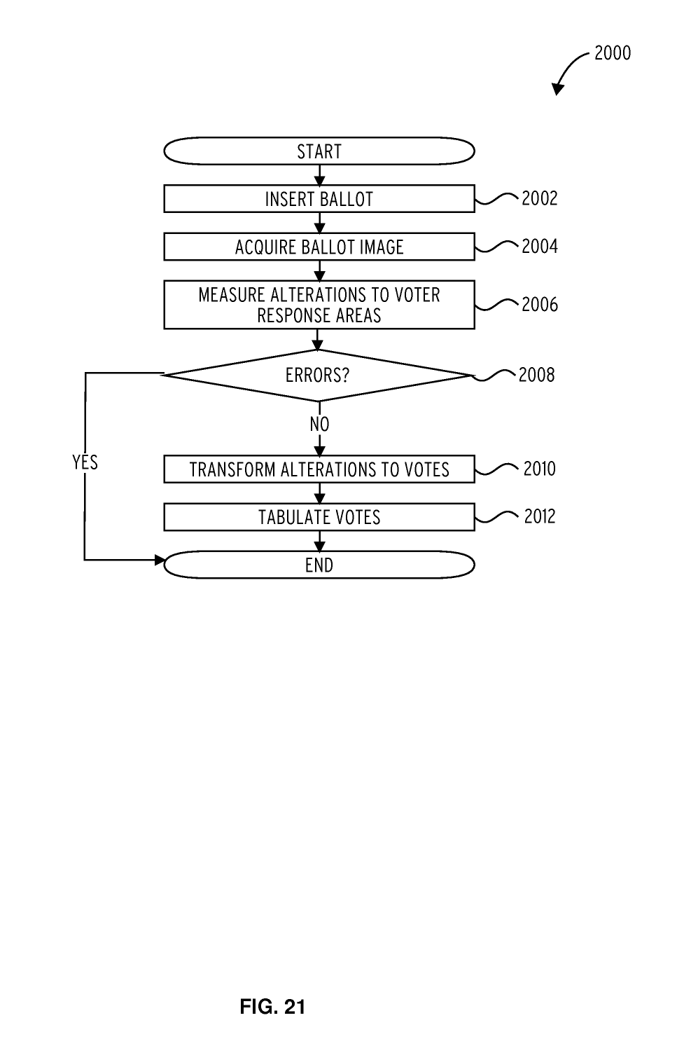

FIG. 21 illustrates an embodiment of a ballot scanning process 2100. At block 2102 the paper ballot is inserted for scanning. A ballot image is acquired from the paper ballot using optical scanning at block 2104. At block 2106 alterations the voter response areas (mark areas) are measured. If an error is detected at decision block 2108, the process concludes. Otherwise, alterations to the mark areas are transformed into votes at block 2110. The votes are then tabulated at block 2112.

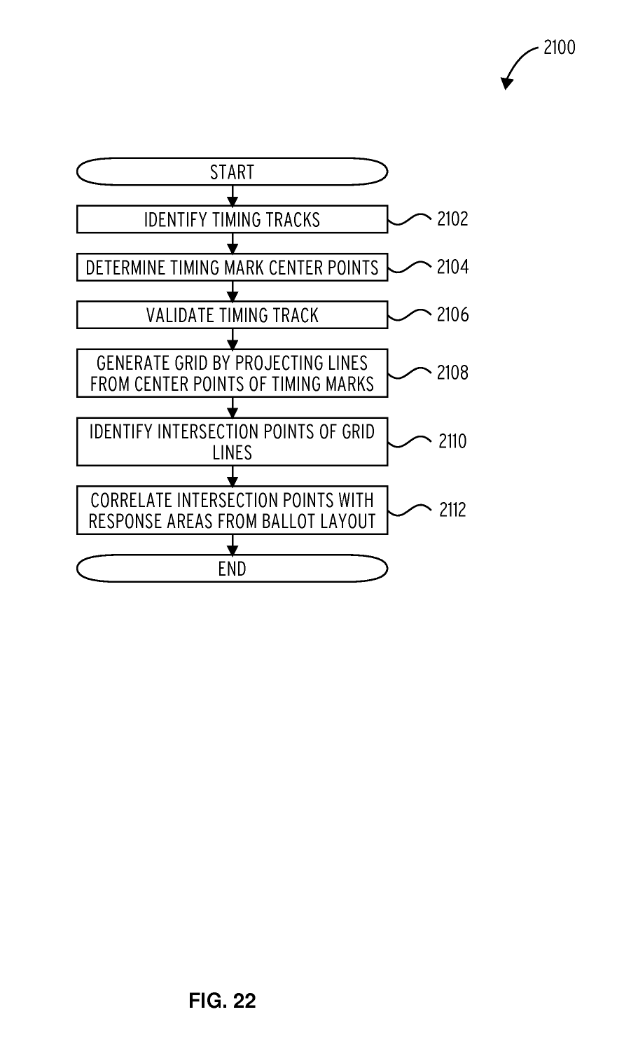

FIG. 22 illustrates an embodiment of a voter response area identification process 2200. Timing tracks are identified on the ballot at block 2202. Center points for the marks are identified at block 2204. The timing tracks are validated (e.g., checked for being well-formed) at block 2206. The grid schema for the ballot is generated by projecting (e.g., extrapolating based on angular differences between corresponding timing marks) lines from the timing mark center points at block 2208. The intersection points of the grid lines are identified at block 2210, and correlated with mark zones at block 2212.

In addition to multiple methods for interpreting the content of the ballot, there are multiple methods for storing the data. These methods can also be implemented using a single ballot counting device that supports multiple methods of counting and storing. In some embodiments, the types of stored data may include: (1) the digital image of each page/side of a single ballot; (2) a set of logs for the analysis of each instance of a mark zone (if applicable), a mark, a text zone, a found text or a found handwriting; (3) a cast vote record (CVR) that records the vote or the lack thereof for each ballot item and each ballot choice, or a CVR that includes only the actual votes, and merely implies that for other ballot choices there was no vote; where applicable with the voting method, the CVR may also contain an indication of the affirmative absence of a choice in a ballot item; (4) a running tally for each ballot choice, updated after each ballot is processed; (5) a sequence of tallies for each ballot choice, with a new version of the tally-set appended to the sequence after each ballot is processed; (6) a final tally-set produced when the counting device performs an orderly shut-down; and (7) meta-data linking these records, such as, for example, a linkage between a ballot image and a CVR.

There are also multiple methods of storage, which may be combined, including multiple redundant instances of the same method of storage to same or similar media types. In some embodiments, these methods may include one or more of: (1) the storage of any of the above data or other data (e.g., log records not related to ballots) on an ordinary read-write stable storage, such as, for example, a hard disk, including over-writing of previous records; (2) append-only storage on a write-once medium, such as, for example, an optical disk; (3) append-only storage via an operating system file system that supports only write-once, regardless of the nature of the underlying storage media; and (4) storage in a networked file system, network access to a separate database server host, or other data repository on a separate network connected host. A combination of methods may be used, such as for ensuring data integrity or providing redundancy. Storage may be implemented all or in part on removable media.

There may be multiple methods of de-serialization of the ballot sequence. Serialization is an important issue because of the privacy and anonymity requirements in voting. If a ballot counting device records each ballot in the order counted, it may be possible to trace a ballot to a specific voter by comparing the ballot sequence with poll book records or by visual observations by poll workers or poll watchers. In some embodiments, the de-serialization options may include: (1) no de-serialization; (2) creating a definitive set of records as a part of an orderly shut-down process, where the definitive set is a random or pseudo random re-ordering of records created serially during the ballot counting process; and (3) the records can be recorded in a partially de-serialized manner as the records are created, using techniques at any (or multiple) storage levels (such as block record-write, file-system I/O, database row creation), in which all or a part of the “new” record is entered into a “holding pen” from which records (or other units) are entered into the main data-store after the pen is full, and the pens are randomly or pseudo-randomly chosen for permanent storage and subsequent deletion from the pens.

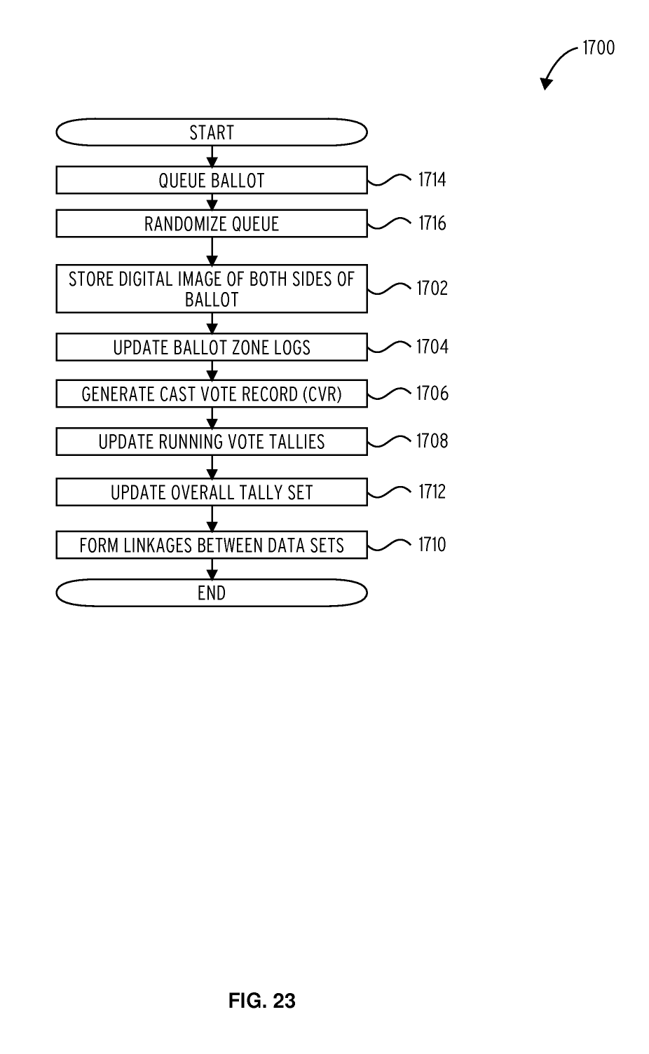

FIG. 23 illustrates an embodiment of a ballot counting process 2300. The ballot is queued for processing at block 2314. The queue is randomized at block 2316 to prevent identification of the voter from the order they voted. A digital image of one or both sides of the ballot is stored at block 2302. Ballot zone logs are updated at 174, and a CVR is generated for the ballot at block 2306. The running vote tallies for particular ballot options are updated at block 2308, and an overall tally set is updated at block 2312. Linkages are formed between some or all of the data sets (e.g., between the CVR and ballot scan image) at block 2310.

In some embodiments, for ballots of the format described above in Ballot A, the counting technique includes: (1) searching the page for master timing marks in expected areas, typically the corners; (2) getting location of the ballot identifier from the timing marks location, and reading ballot identifier; (3) using the mapping defined for the ballot identifier; (4) searching for timing marks for rows and columns to set grid for mark zones; (5) searching the grid for the mark zones that the mapping indicates as used; (6) where a mark is found, mapping from the mark zone to the ballot option for which it stands; and (7) recording a vote for that ballot option.

Finding a mark is a digital imaging processing task that can use any of a family of parameterized techniques, or meta-techniques specifying the selection of multiple techniques, and how to relate their disparate findings. Techniques used here for “finding a mark” apply to any method that includes finding a mark. For example, a mark zone is a fixed set of pixels and “finding a mark” could include finding a used mark zone where >50% of the pixels were dark.

Many other techniques and combinations are possible for finding a mark.

In some embodiments, for ballots of the format described above in Ballot B, the counting technique includes: (1) searching the page for timing marks and a ballot identifier; (2) using the subset of the election definition defined for the ballot identifier; (3) searching the used mark zones for marks based on the grid defined by timing marks; (4) where a mark is found, searching for text in a location pre-defined explicitly by timing marks, pre-defined explicitly by machine-readable data in the head or footer or other predictable location, pre-defined explicitly based on the election definition, or pre-defined implicitly as a standard or expectation; (5) if a text is found and recognized using OCR, and if the text matches a ballot option in the election definition, recording a vote for that ballot option.

Alternatively, the text match can be done on a compact code rather than a candidate name if the election definition provides the compact code for each ballot choice. For example, one line on such a ballot would be, from left to right, a machine printed mark, a compact code such as “009”, a candidate name such as “John Quincy Adams”.

One parameter of such a process is a choice of one or more matching specifications. OCR does sometimes create errors, for example, “Johm Quincy Adans.” In some embodiments, the configuration of a ballot counting device can include one or more methods of determining a match, such as, for example, an exact match, an N-character string match, or a match of M out of N characters with the remainder being variations introduced by OCR errors. Choices may vary depending on circumstance. For example, in a central-counting scenario where there is an operator to consult, anything other than an exact match might be flagged and referred to the operator for human resolution.

The counting technique for Ballot C is essentially the same process as for Ballot B, except that there are no non-selected choices to ignore, and no separate headers for ballot items. Typically every mark zone in the ballot would have a machine-printed mark, and located near it would be a ballot item and a ballot choice, such as, for example, “U.S. Senator—John Quincy Adams”.

Alternatively, the counting can rely on compact codes in an election definition rather than the ballot item or ballot choice.

An alternative embodiment omits most timing marks, and uses the master timing marks to indicate the location of lines of text to be OCRed without the need for a mark.

The counting technique for Ballot D is essentially the same process as for Ballot C with the same variations, but with additional text matching. The fact that the ballot item name and the ballot choice text are directly entered by a voter rather than by a DBM offering the choices actually on the ballot does not significantly change the location and OCR process. However, there is a much greater likelihood that a ballot item name or a ballot choice text provided will not match those listed in the election definition or the ballot definition. As with Ballot B and Ballot C, an exact match of text after a successful OCR results in the recording of a vote; anything else is likely a printing error or scanning error. In the case where an exact match in the user-provided text is lacking, other approaches are available to ascertain a possible partial match, and notify a human operator who can intervene and make a definitive judgment about whether the text constitutes a valid vote.

The counting technique for Ballot E can be essentially the same as the process for Ballot D, but may utilize an automated handwriting analysis instead of OCR.

The counting technique for Ballot F is essentially the same as the process for Ballot E, but may require additional digital image processing to locate regions that may contain handwriting, rather than relying on the master timing marks and a predefined page layout.

The counting technique for Ballot G is essentially the same as the process for Ballot D, but may require additional digital image processing to locate regions that may contain OCR text, rather than relying on the master timing marks and a predefined page layout.

The counting technique for Ballot H is essentially the same as the process for Ballot C, but is simplified because only one ballot item and one ballot choice are present. Ballot identifiers and timing marks would be largely superfluous and may be omitted in this case.

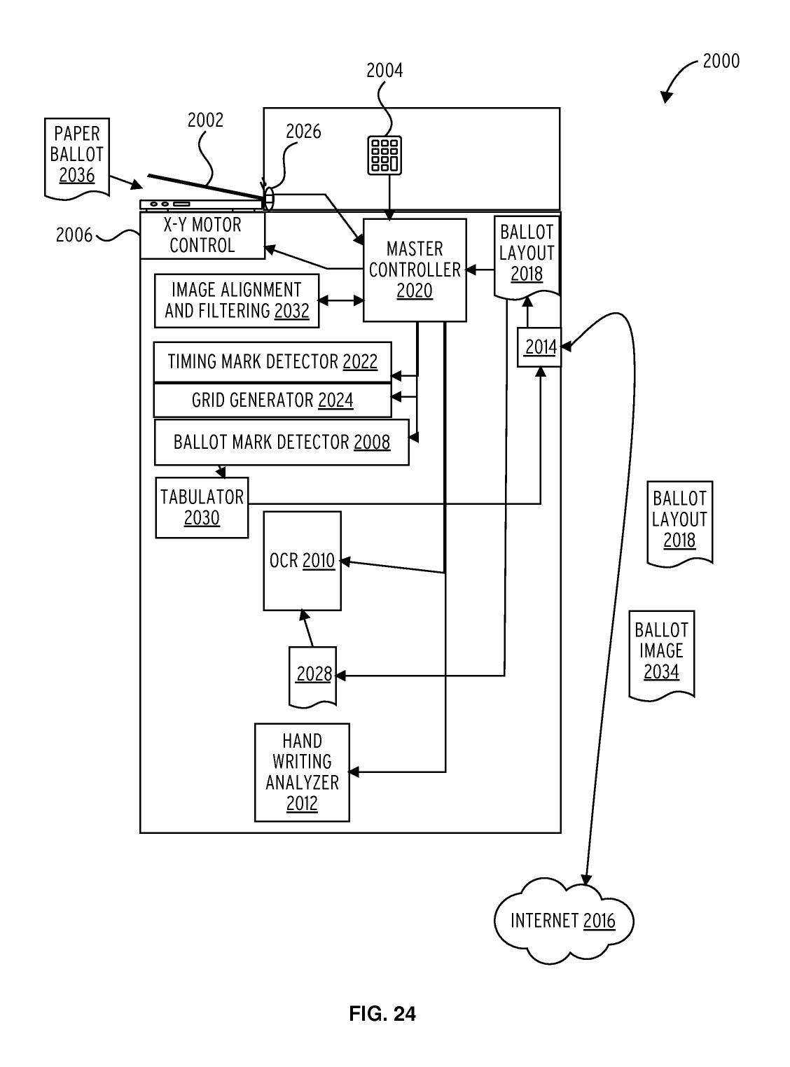

FIG. 24 illustrates an embodiment of a ballot tabulation apparatus 2400. The ballot tabulation apparatus 2400 comprises a master controller 2420 that coordinates and controls operations of other components, as configured by a ballot layout definition 2418 received either via a control panel 2404 (e.g., keyboard), a scan bed 2402, or in many embodiments, via a network communication interface 2414 coupled to a machine communication network 2416 such as the Internet. The ballot tabulation apparatus 2400 may tabulate a paper ballot 2436 scanned via the scan bed 2402, and/or electronic ballots received as structured data (e.g., XML) or as a digital ballot image 2434 of a paper ballot.

For a scanned paper ballot 2436 or a received ballot image 2434, the master controller 2420 operates as configured by the ballot layout definition 2418 to identify and tabulate vote selections. For structured data ballots, an XML or other standard parsing logic may be applied by the master controller 2420 to ascertain and tabulate vote selections.

A digital image of a paper ballot 2436 may be obtained by the master controller 2420 by operating the X-Y motor control 2406 on the optical read head sensor 2426 to scan a paper ballot 2436 placed on the scan bed 2402. The digital image thus obtained may be processed to remove noise (stray pixels for example, to color correct and improve contrast, and to align the image in the event the paper ballot 2436 was skewed on the scan bed 2402.

The master controller 2420 may then operate the timing mark detector 2422 to identify and locate timing marks, and to further assist with image alignment. Identified timing marks may be applied to the grid generator 2424, and the generated grid schema applied to ballot mark detector 2408, as previously described. OCR 2410 (as configured by positive identification configuration settings 2428) and/or hand writing analyzer 2412 may be applied to identify selections associated with mark zones when the ballot layout definition 2418 does not correlate the mark zones to selections.

Once the ballot marks are identified they may be tabulated by the tabulator 2430, as previously described.

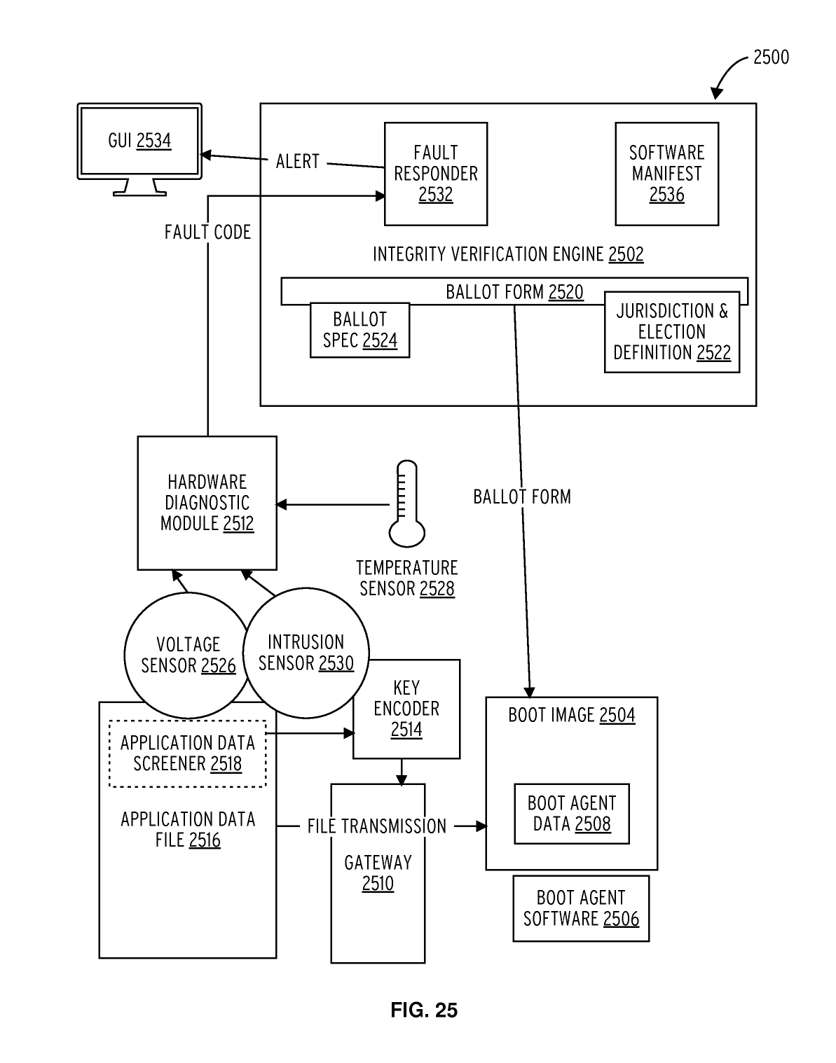

FIG. 25 is a figure describing an embodiment of an integrity verification system 2500 for configuring and validating a ballot casting and counting device.

The system may transform a jurisdiction and election definition, a ballot spec and additional data into a ballot form; receive a software manifest; transform hardware status records from a group of sensors into a hardware integrity validator; scan memory locations within a boot medium for a ballot and election data markers; flag a ballot and election data location in memory; read each specified memory location and encode a gateway key; transmit the gateway key to a gateway actuator to allow a application code file through a gateway; combine application code files to create a boot image; check the integrity of the boot image; and/or copy the ballot form into the ballot and election data location in memory.

In some embodiments, the software manifest may include a group of file designations and memory locations for an application code files.

In some embodiments, encoding the gateway key may further include reading each byte of memory and/or compiling a checksum or cryptographic hash corresponding to encoded data.

In some embodiments, transforming hardware status records from the group of sensors into the hardware integrity validator may include receiving a temperature record; receiving a voltage record; receiving an intrusion record; converting the temperature record, the voltage record and the intrusion record into numerical values; and/or combining the numerical values for the temperature record, the voltage record and the intrusion record with a safety limit metric into the hardware integrity validator.

In some embodiments, a fault responder 2532 receives a fault code and in response issues an alert to a user via a GUI 2534 or takes other measures to insure the safety and integrity of the system such as shutting down the power.

In some embodiments, a system for voting system validation may include a hardware diagnostic module to transform a status record into a fault code, a group of sensors to monitor hardware integrity and transmit status records to the hardware diagnostic module, a gateway to control the transmission of an application code file, a gateway actuator to control the activation of the gateway, a key encoder to transform stored byte values into a gateway key and transmit the gateway key to the gateway actuator, an application data screener to scan the application code file and transmit stored byte values to the key encoder, and/or an integrity verification engine to transform a jurisdiction and election definition and a ballot spec into a ballot form.

In some embodiments, the hardware diagnostic module may further include a group of hardware integrity validators to receive the status record and transform it into a hardware integrity status, a group of hardware fault switches to control the transmission of the hardware integrity status, and/or a fault encoder to transform the hardware integrity validator into the fault code.

In some embodiments, the integrity verification engine may further include a fault responder to receive the fault code and transform it into an alert and/or a logic to transform the ballot spec and the jurisdiction and election definition into the ballot form.

In some embodiments, a method for configuring and validating a ballot casting and counting device may include transforming a jurisdiction and election definition, a ballot spec and additional data into a ballot form; receiving a software manifest; transforming hardware status records from a group of sensors into a hardware integrity validator; scanning memory locations within a boot medium for a ballot and election data markers and flagging a ballot and election data location in memory; scanning each software manifest memory location and encoding a gateway key; transmitting the gateway key to a gateway actuator to allow a application code file through a gateway; transforming application code files into a boot image; checking the integrity of the boot image; and/or copying the ballot form into the ballot and election data location in memory.

In some embodiments, the receiving a software manifest may include a group of file designations and memory locations for application code files.

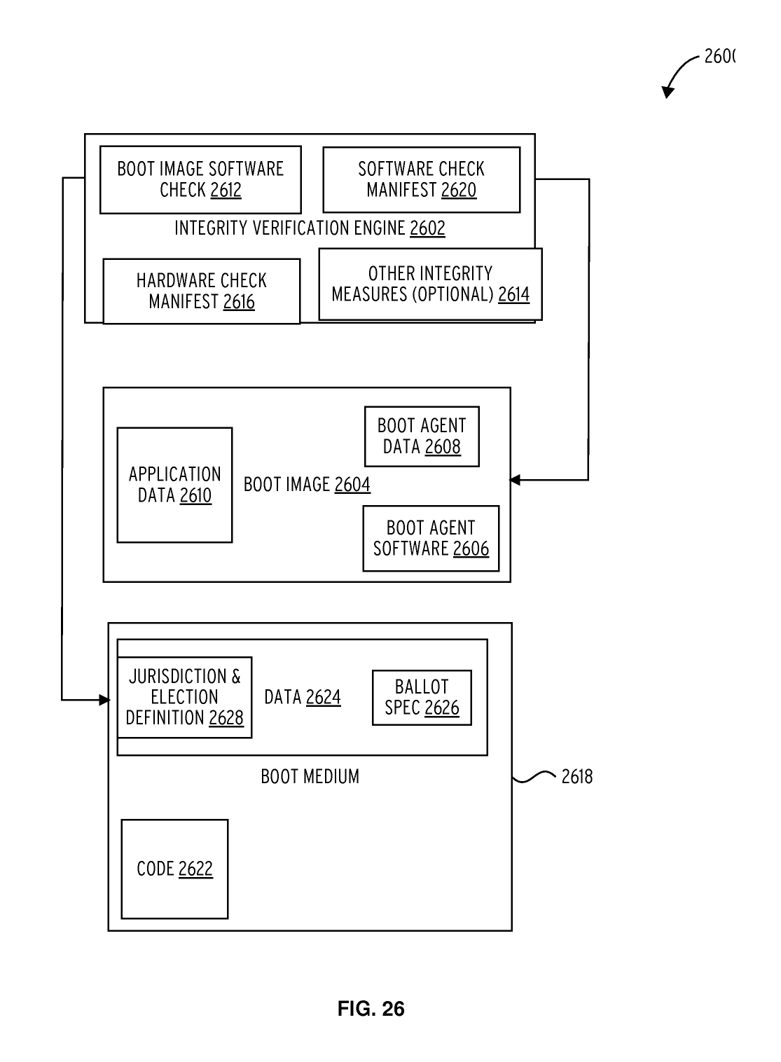

FIG. 26 illustrates an embodiment of a device manager 2600.

The device manager 2600 isolates data from application code in the disk image. The boot manifest enumerates the files included in the software package which should not have changed since the last certification of the disk image. The device manager 2600 increases fault tolerance by implementing integrity testing by such means as checksums, cryptographic hashes or cyclic redundancy checks.

The software check manifest 2620 comprises information regarding the files in the form of checksums or a cryptographic hash. In the instance of a cryptographic hash, small changes in the code will cause a massive change in the hash value and alert the integrity verification engine 2602 to a change in the disk image data.

Performing these checks prior to fully initializing the booting process allows the device manager 2600 to isolate any changes to the code which may have occurred through data corruption or the addition of malicious code. In addition, by utilizing an execution “whitelist” and limiting the ability to modify or add to the previously verified software base as it is stored, the device manager 2600 reduces or eliminates the need for integrity testing at runtime, thereby increasing the efficiency of the system and allowing for resources to be allocated to other tasks.

In some embodiments, before being used for actual ballot casting and counting, every voting machine may be validated in a process that includes correctness testing, such as, for example, logic and accuracy testing, and/or integrity testing. Validation includes confirming that the device's hardware and software matches a specific configuration that was defined during a previous system certification. In practice, integrity testing of most existing products is difficult because of software design and physical design limitations.

In some embodiments the device manager 2600 takes inputs such as the ballot specification and other data (collectively, the jurisdiction & election definition 2628), creates a boot image 2604 for the ballot casting and counting device to be validated and loads the boot image 2604, a boot agent software 2606 and a boot agent data 2608 and application Data 2610 into a boot medium 2618 for booting the ballot casting and counting device.

In some embodiments, the boot image 2604 is invariant from election to election and from date to date. The boot medium 2618 may also include data 2624 (such as a jurisdiction & election definition 2628 or other configuration data such as a ballot spec 2626) which may vary from election to election. In some embodiments, the boot medium 2618 can be read-only storage medium or a flash device.

The boot image 2604 may be implemented as a computer file. When the boot image 2604 is transferred onto the boot medium 2618, it enables the associated hardware to start up. In some embodiments, the boot image 2604 includes an image of the operating system, utilities and diagnostics, configuration data and application software, as well as boot and data recovery information. A pure boot image 2604 contains no data that cannot be reproduced from the device configurations or off-the-shelf executables. In particular, end-user data its not part of the boot image Therefore, the boot image 2604 remains the same from election to election and from date to date which can be checked and verified by the integrity verification engine 2602.

The boot agent software 2606 is a software that, when executed, boots the device using the boot image 2604 and the data 2624. Integrity verification engine 2602 performs both hardware and software checks using software check manifest 2620, hardware check manifest 2616, and software (SW) checksum that is integral to itself. This manifestation is one in which the integrity verification engine 2602 is on the boot medium 2618, following the hardware (HW) conventions for being the code that the HW's power-system, and firmware (often called BIOS) will launch from the boot medium 2618. This configuration may be referred to as a boot loader, that is, the boot medium 2618 comprises a small program that the BIOS loads and this small program loads the actual OS. The integrity verification engine 2602 may thus be implemented as a boot loader that first does some integrity checks before committing to the full boot.

Variants include the use of a custom BIOS, where one of the following is performed: the BIOS firmware itself includes the code for a HW check using its own manifest and the code for a SW checksum check—there is no boot agent per se just a boot loader; the BIOS firmware itself includes the code for a HW check using its own manifest and a boot agent does the SW check; the BIOS firmware itself includes the code for a SW check, and a boot agent does the HW check. Alternatively, instead of the BIOS firmware including the HW manifest and/or the SW checksum, the HW manifest and/or the SW checksum are on the boot media in predictable places for the BIOS to find and use. In another alternative, instead of the HW manifest and/or the SW checksum, the HW manifest and or the SW checksum are on the boot media in predictable places for the BIOS to find and use. In another alternative, instead of the HW manifest and the SW checksum being on the same media the HW manifest and the HW manifest and/or the SW checksum are on separate storage media (not in the firmware and not in the boot image), including one option where they are on removable media.

Another set of variants is on the principle manifestation in which the boot medium contains all of the boot agent code, boot agent data, boot image and application data. The application data can be on separate media (which may be removable) so that the boot medium contains all of the boot agent code, boot agent data, boot image, and application data. The application data can be on separate media (which may be removable), or at least not intended to be easily removed. In one implementation, the HW manifest and the SW checksum are on separate storage media (not in the firmware and not in the boot image), including one option where they are on removable media even though the boot media is not physically managed by an operator, a device cannot boot unless an operator inserts removable media with the HW manifest and/or the SW checksum for the boot agent to use.

In some embodiments, during device booting, the boot agent software checks the device hardware with a boot agent manifest, which is a file that contains information about accompanying files and enumerates the files included in the package. The manifest may optionally contain a cryptographic hash or checksum of each file. By creating a cryptographic signature for such a manifest file, the entire contents of the distribution package can be validated because any alternating of the files will invalidated the checksums in the manifest file.

In some embodiments, during system booting the boot agent software also checks against the integrity of the boot image by methods such as checksums or cyclic redundancy checks.

In some embodiments, address space layout randomization (ASLR) may be used to help maintain system integrity by limiting the ability to modify or add to the previously verified software as the software is running. ASLR is a computer security technique to protect a system from attacks. It is based upon the low chance of an attacker guessing the location of randomly placed areas. ASLR randomly arranges the positions of key data areas of a program to hinder security attacks by making it more difficult for an attacker to predict the target address. To defeat the randomization, attackers must successfully guess the positions of all areas they wish to attack and a mistaken guess is usually not recoverable because it will cause the application to crash.

In some embodiments, an execution whitelist may be used to help maintain system integrity by limiting the ability to modify or add to the previously verified software base as it is stored, before it is launched or running. A whitelist is a list of applications that are being provided and are allowed to be run on a system. Whitelisting is the reverse of blacklisting. If a system keeps a whitelist of applications, only applications on the list can be accepted for use. Therefore users with no system administration privilege are not able to download, install or use programs or applications that have not been deemed appropriate for use.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

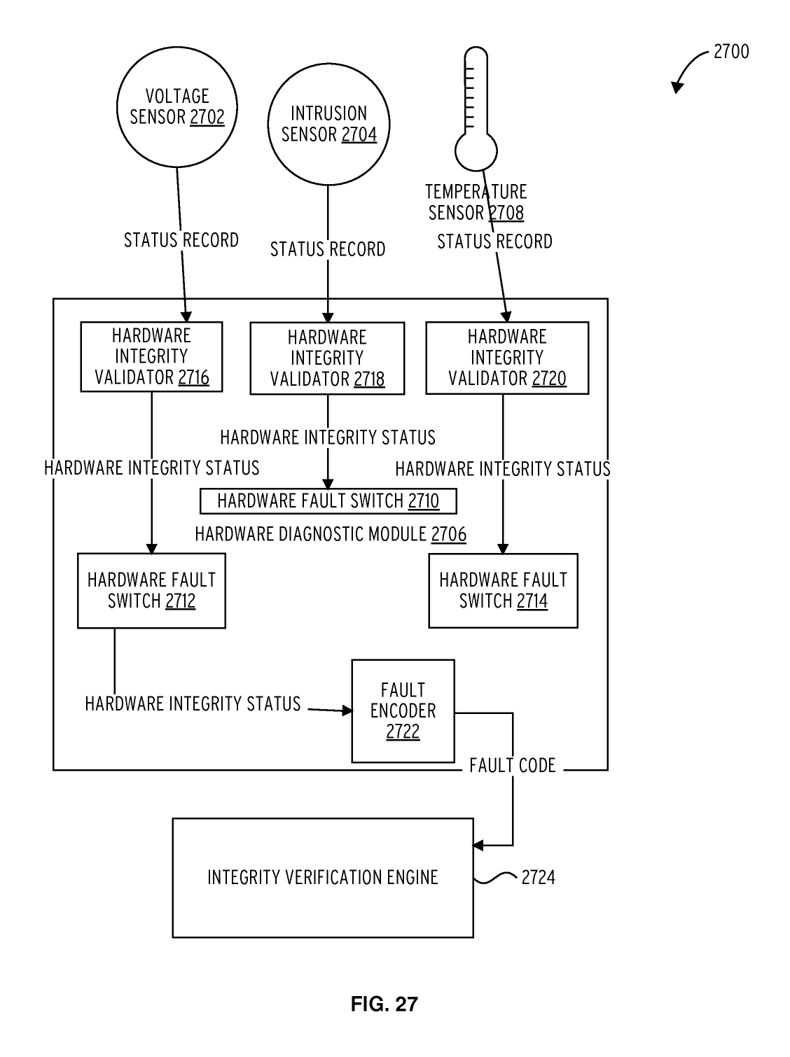

FIG. 27 is a figure illustrating an embodiment of a hardware diagnostic module 2706 of a hardware diagnostic system 2700. Sensors such as a voltage sensor 2702, intrusion sensor 2704 and temperature sensor 2708 transmit status records to the hardware diagnostic module 2706. The hardware integrity validator 2716, hardware integrity validator 2718, and hardware integrity validator 2720 within hardware diagnostic module 2706 receive the status records and transform them into numerical values and combine them with a safety limit metric into a hardware integrity status. Each hardware integrity status is encoded into an electrical signal and transmitted to hardware fault switch 2710, hardware fault switch 2712 or hardware fault switch 2714 corresponding to they type of hardware fault that may occur. A hardware fault switch 2710, hardware fault switch 2712 or hardware fault switch 2714 receives an electrically encoded hardware integrity status and if there is a fault of some kind, the corresponding hardware fault switch 2712 switch is closed and the hardware integrity status passes through the hardware fault switch 2712 to the fault encoder 2722. The fault encoder 2722 receives a hardware integrity validator from hardware fault switch 2712 and registers the fault cause and encodes it as a fault code corresponding to the type of hardware fault registered and transmits the fault code to the integrity validation engine.

In some embodiments, transforming hardware status records from the group of sensors into the hardware integrity validator may include receiving a temperature record; receiving a voltage record; receiving an intrusion record; converting the temperature record, the voltage record and the intrusion record into numerical values; and/or combining the numerical values for the temperature record, the voltage record and the intrusion record with a safety limit metric into the hardware integrity validator.

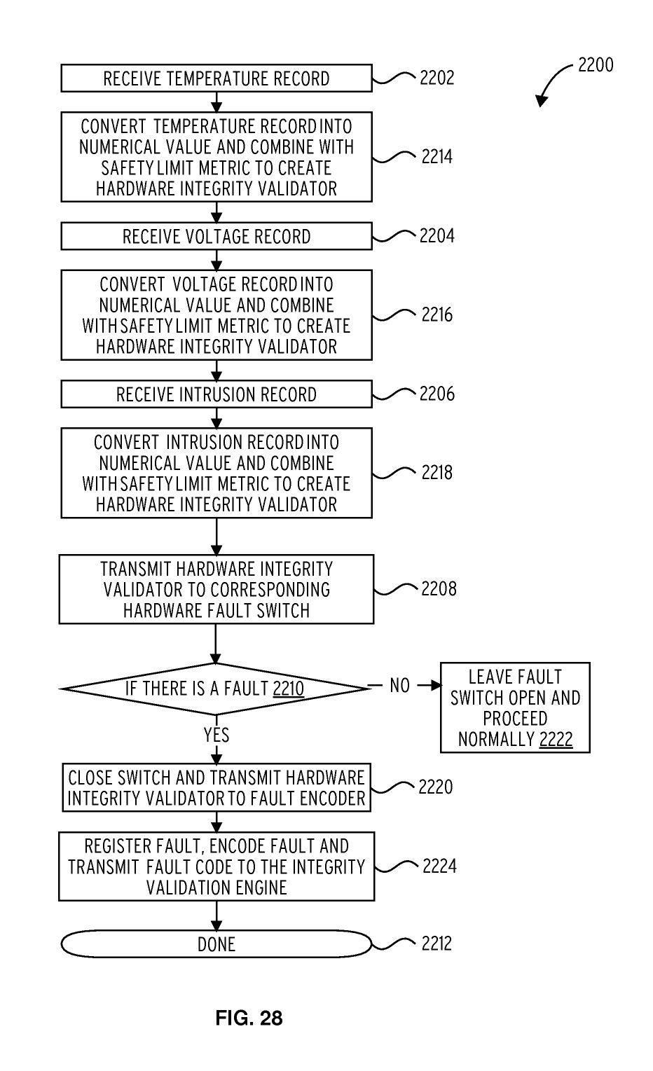

FIG. 28 illustrates a routine 2800 for configuring and validating a ballot casting and counting device in accordance with one embodiment.

In block 2802, routine 2800 receives a temperature record from a temperature sensor.

In block 2814, routine 2800 transforms a temperature record into a numerical value and combines it with a safety limit metric to create a hardware integrity validator.

In block 2804, routine 2800 receives a voltage record from a voltage sensor.

In block 2816, routine 2800 transforms a voltage record into a numerical value and combines it with a safety limit metric to create a hardware integrity validator.

In block 2806, routine 2800 receives an intrusion record from an intrusion sensor.

In block 2818, routine 2800 transforms an intrusion record into a numerical value and combines it with a safety limit metric to create a hardware integrity validator.

In block 2808, routine 2800 transmits the hardware integrity validator to a corresponding hardware fault switch.

In decision block 2810, routine 2800 if the hardware fault switch registers a fault then in block 2820 switch is closed and the hardware integrity validator is transmitted to the fault encoder.

In block 2824, routine 2800 the fault encoder registers the fault, encodes it and transmits the fault code to the integrity validation engine.

If the hardware fault switch does not register a fault, then in block 622 the switch remains open and nothing is transmitted.

In done block 2812, routine 2800 ends.

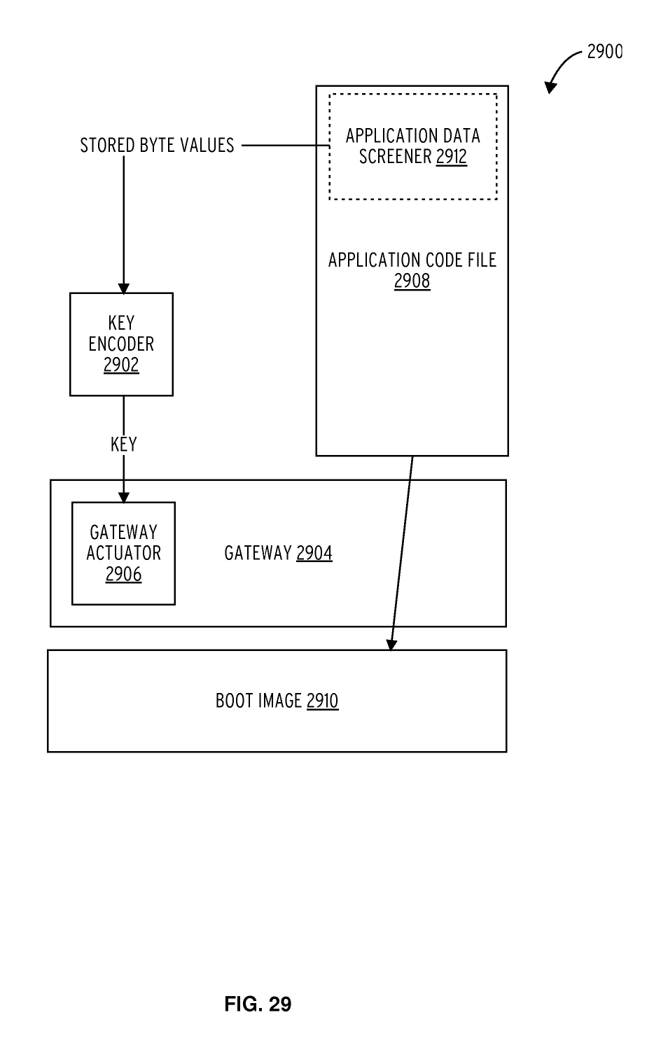

FIG. 29 illustrates an embodiment of an application data screener, gateway and gateway actuator 2900.

In one embodiment, application data screener 2912 examines the stored bytes in memory of application code file 2908 and transmits the collected byte values to key encoder 2902. Key encoder 2902 encodes a key using a checksum method or cryptographic hash table. Key encoder 2902 transmits the key to gateway actuator 2906. Gateway actuator 2906 compares the key to a list of valid keys and if the key is valid, then gateway actuator 2906 opens gateway 2904 and application code file 2908 is transmitted through gateway 2904 and added to boot image 2910.

In some embodiments, encoding the gateway key may further include scanning each byte of memory and/or compiling checksums based on byte values to encode data.

In some embodiments, encoding the gateway key may further include scanning each byte of memory and/or using a cryptographic hash function to encoded data.

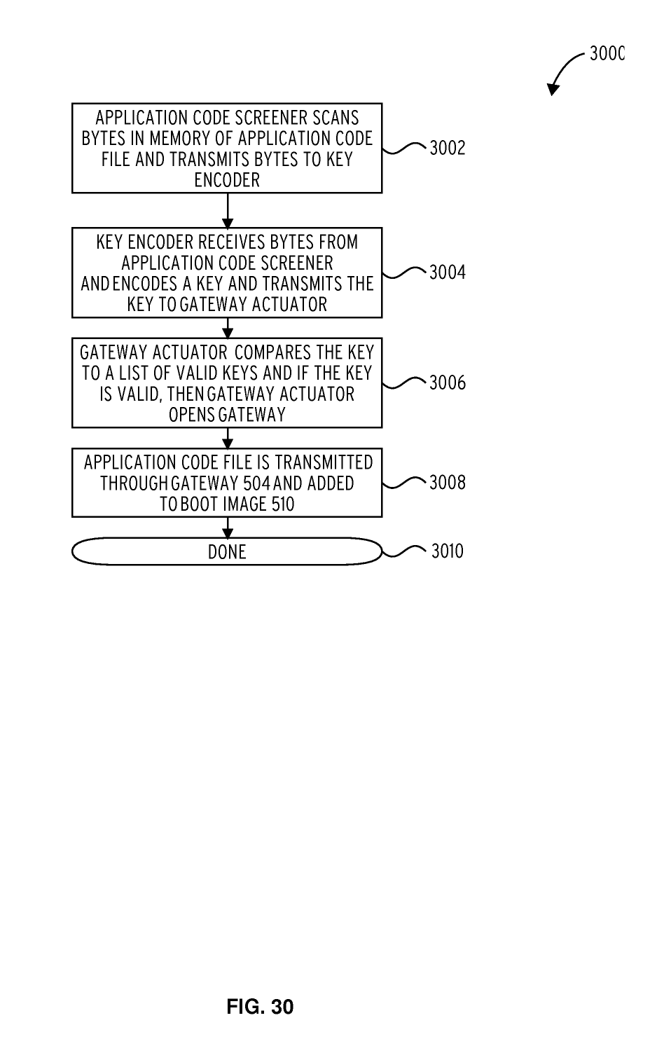

FIG. 30 illustrates an embodiment of a process of validation application code files 3000.

In block 3002, of process of validation application code files 3000 an application data screener scans stored bytes in memory of an Application code file 508 and transmits the collected byte values to a key encoder.

In block 3004, of process of validation application code files 3000 a key encoder encodes a key using a checksum method or cryptographic hash table and transmits the key to gateway actuator.

In block 3006, of process of validation application code files 3000 gateway actuator compares the key to a list of valid keys and if the key is valid, then gateway actuator opens the gateway.

In block 3008, of process of validation application code files 3000 the application code file is transmitted through the gateway and added to the boot image.

In done block 3010, process of validation application code files 3000 ends.

In block 3102, routine for configuring and validating a ballot casting and counting device 3100 transforms jurisdiction and election definition.

In block 3104, routine for configuring and validating a ballot casting and counting device 3100 receives a software manifest.

In block 3106, routine for configuring and validating a ballot casting and counting device 3100 transforms hardware status records from a plurality of sensors into a hardware integrity validator.

In block 3108, routine for configuring and validating a ballot casting and counting device 3100 scans memory locations within a boot medium for a ballot and election data markers.

In block 3110, routine for configuring and validating a ballot casting and counting device 3100 flags a ballot and election data location in memory.

In block 3112, routine for configuring and validating a ballot casting and counting device 3100 reads each specified memory location and encoding a gateway key.

In block 3114, routine for configuring and validating a ballot casting and counting device 3100 transmits the gateway key to a gateway actuator to allow a application code file through a gateway.

In block 3116, routine for configuring and validating a ballot casting and counting device 3100 combines application code files to create a boot image.

In block 3118, routine for configuring and validating a ballot casting and counting device 3100 checks the integrity of the boot image.

In block 3120, routine for configuring and validating a ballot casting and counting device 3100 copies the ballot form into the ballot and election data location in memory.

In done block 3122, routine for configuring and validating a ballot casting and counting device 3100 ends.

1. (canceled)

2. A method of spatial-temporal division of digital balloting, the method comprising:
at a first time, operating a digital network between a ballot provisioning system and an end user device to:
correlate a physical location provided over the network to the ballot provisioning system with a digital ballot corresponding to the physical location;
communicate the ballot, without user identification or authentication, from the ballot provisioning system to the end user device;
at a second time after the first time, operating a ballot marking system operationally independent from the ballot provisioning system to receive the ballot from the end user device and to enable the user to anonymously mark the ballot;
at a third time after the second time, operating a ballot packaging system operationally independent from the ballot provisioning system and the ballot marking system to form a first anonymous digital envelope around the ballot; and
at a fourth time after the third time, operating a ballot submission system operationally independent from the ballot provisioning system, the ballot marking system, and the ballot packaging system to:
generate an authenticated outer digital envelope around the first anonymous digital envelope to form a double enveloped digital ballot; and
receive the double enveloped digital ballot over the network interface.

3. The method of spatial-temporal division of claim 2, further comprising:
utilizing an anonymizing proxy service between the end user device and the ballot provisioning system.

4. The method of spatial-temporal division of claim 2, further comprising:
at the first time, validating that the physical location is a valid voter registration address and correlating the voter registration address to a precinct; and
communicating a precinct identifier to the end user device.

5. The method of spatial-temporal division of claim 4, further comprising:
the precinct identifier is one of a U.S. Federal Information Processing Standards (FIPS) unique numeric identifier, an ordinal number combined with a county and state name, or a precinct name.

6. The method of spatial-temporal division of claim 2, further comprising:
the physical location is a location for the end user device; and
correlating a residence address of the user to the location for the end user device.

7. The method of spatial-temporal division of claim 6, further comprising:
communicating to the user a selection of a plurality of digital ballots for a plurality of precincts in which cross-over voting is permitted for the residence address of the user.

8. The method of spatial-temporal division of claim 6, further comprising:
at the first time, communicating to the end user device an activation control for the ballot marking system; and
at the first time, communicating to the end user device an activation control for the ballot submission system.

9. The method of spatial-temporal division of claim 2, further comprising:
subsequently to the first time, determining an eligibility of the user to vote in a precinct corresponding to the precinct identifier.
